(19) United States
(12) Patent Application Publication
(10) Pub. No.: US 2026/0255353 A1
(43) Pub. Date: Aug. 27, 2026

(54) UE INITIATED UL TRANSMISSIONS

(71) Applicant: Samsung Electronics Co., Ltd., Suwon-si (KR)

(72) Inventors: Emad Nader Farag, Flanders, NJ (US); Eko Onggosanusi, Coppell, TX (US); Dalin Zhu, Allen, TX (US); Md. Saifur Rahman, Plano, TX (US)

(21) Appl. No.: 19/534,499

(22) Filed: Feb. 9, 2026

Related U.S. Application Data
(60) Provisional application No. 63/761,748, filed on Feb. 21, 2025.
(60) Provisional application No. 63/763,708, filed on Feb. 26, 2025.
(60) Provisional application No. 63/769,542, filed on Mar. 10, 2025.

(51) Int. Cl. H04W 72/21; H04L 5/00

(52) U.S. Cl. CPC H04W 72/21; H04L 5/0092

(57) ABSTRACT

Apparatuses and methods for user equipment (UE) initiated uplink (UL) transmissions. A method performed by a UE includes receiving first information related to a configured grant physical uplink shared channel (CG-PUSCH) for a UE initiated report, receiving second information related to a physical uplink control channel (PUCCH) associated with the CG-PUSCH, and receiving a physical downlink control channel (PDCCH) with a downlink control information (DCI) format scheduling uplink shared channel (UL-SCH) transport block on a PUSCH. The DCI includes a flag. An instance of the CG-PUSCH and the PUSCH collide. The method further includes determining a presence of the UE initiated report for transmission in the instance of the CG-PUSCH and determining, based on the flag, whether to transmit the instance of the CG-PUSCH or the PUSCH.

### CROSS-REFERENCE TO RELATED AND CLAIM OF PRIORITY

The present application claims priority under 35 U.S.C. § 119(e) to U.S. Provisional Patent Application No. 63/761,748 filed on Feb. 21, 2025; U.S. Provisional Patent Application No. 63/763,708 filed on Feb. 26, 2025; and U.S. Provisional Patent Application No. 63/769,542 filed on Mar. 10, 2025, which are hereby incorporated by reference in their entirety.

### TECHNICAL FIELD

The present disclosure relates generally to wireless communication systems and, more specifically, the present disclosure is related to user equipment (UE) initiated uplink (UL) transmissions.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to UE initiated UL transmissions.

In one embodiment, a user UE is provided. The UE includes a transceiver configured to receive first information related to a configured grant physical UL shared channel (CG-PUSCH) for a UE initiated report, receive second information related to a physical UL control channel (PUCCH) associated with the CG-PUSCH, and receive a physical downlink control channel (PDCCH) with a downlink control information (DCI) format scheduling uplink shared channel (UL-SCH) transport block on a PUSCH. The DCI includes a flag. An instance of the CG-PUSCH and the PUSCH collide. The UE further includes a processor operably coupled to the transceiver. The processor is configured to determine a presence of the UE initiated report for transmission in the instance of the CG-PUSCH and determine, based on the flag, whether to transmit the instance of the CG-PUSCH or the PUSCH.

In another embodiment, a base station (BS) is provided. The BS includes a transceiver configured to transmit first information related to a CG-PUSCH for a UE initiated report and transmit second information related to a PUCCH associated with the CG-PUSCH. A processor operably coupled to the transceiver, the processor configured to schedule an UL-SCH transport block on a PUSCH. The transceiver is further configured to transmit a PDCCH with a DCI format related to scheduling of the UL-SCH on the PUSCH. The DCI includes a flag. The flag indicates whether to transmit an instance of the CG-PUSCH or the PUSCH, when the instance of the CG-PUSCH and the PUSCH collide, and a UE has a UE initiated report to transmit on the instance of the CG-PUSCH.

In yet another embodiment, a method performed by a user equipment is provided. The method includes receiving first information related to a CG-PUSCH for a UE initiated report, receiving second information related to a PUCCH associated with the CG-PUSCH, receiving a PDCCH with a DCI format scheduling UL-SCH transport block on a PUSCH. The DCI includes a flag. An instance of the CG-PUSCH and the PUSCH collide. The method further includes determining a presence of the UE initiated report for transmission in the instance of the CG-PUSCH and determining, based on the flag, whether to transmit the instance of the CG-PUSCH or the PUSCH.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station (BS) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example beam operation in a wireless communication system according to embodiments of the present disclosure;

FIG. 5B illustrates an example multi-beam operation in a wireless communication system according to embodiments of the present disclosure;

FIG. 6 illustrates an example of a transmitter structure for beamforming according to embodiments of the present disclosure;

FIG. 7 illustrates a diagram of example physical UL control channel (PUCCH) resource sets according to embodiments of the present disclosure;

FIG. 8 illustrates an example channel coding process for an uplink shared channel (UL-SCH) according to embodiments of the present disclosure;

FIG. 9 illustrates an example channel coding process for UL control information (UCI) according to embodiments of the present disclosure;

FIG. 10 illustrates an example physical uplink shared channel (PUSCH) process 1000 according to embodiments of the present disclosure;

FIGS. 11A and 11B illustrate multiplexing examples for ACK, CSI-part1, CSI-part2 and UL-SCH on a PUSCH according to embodiments of the present disclosure;

FIGS. 12A and 12B illustrate an example downlink medium access control protocol data unit (DL MAC PDU) and an example uplink medium access control protocol data unit (UL MAC PDU), respectively, according to embodiments of the present disclosure;

FIGS. 13A and 13B illustrate examples of UE initiated beam (or measurement) reporting according to embodiments of the present disclosure;

FIGS. 14A and 14B illustrate alternative examples of UE initiated beam (or measurement) reporting according to embodiments of the present disclosure;

FIG. 15 illustrates an example diagram of physical layer processing according to embodiments of the present disclosure;

FIGS. 16A-16E illustrate examples of overlapping UE initiated reporting according to embodiments of the present disclosure;

FIG. 17 illustrates an example of UE initiated reporting according to embodiments of the present disclosure;

FIGS. 18-21 illustrate examples of UE initiated reporting that handle the overlap or collision between dynamic grant physical uplink shared channel (DG PUSCH) and configured grant physical uplink shared channel (CG PUSCH) for UE initiated report (UIR) according to embodiments of the present disclosure;

FIG. 22 illustrates an example of UE initiated reporting having minimum gaps between channels according to embodiments of the present disclosure;

FIG. 23 illustrates an example of three levels of multiplexing according to embodiments of the present disclosure;

FIGS. 24A and 24B illustrate examples of first level multiplexing according to embodiments of the present disclosure;

FIG. 25 illustrates an example of second level multiplexing according to embodiments of the present disclosure;

FIG. 26 illustrates an example of multiplexing of UCI types and channel coding according to embodiments of the present disclosure;

FIG. 27 illustrates an example of multiplexing UCI according to embodiments of the present disclosure; and

FIG. 28 illustrates an example method performed by a UE in a wireless communication system according to embodiments of the present disclosure.

### DETAILED DESCRIPTION

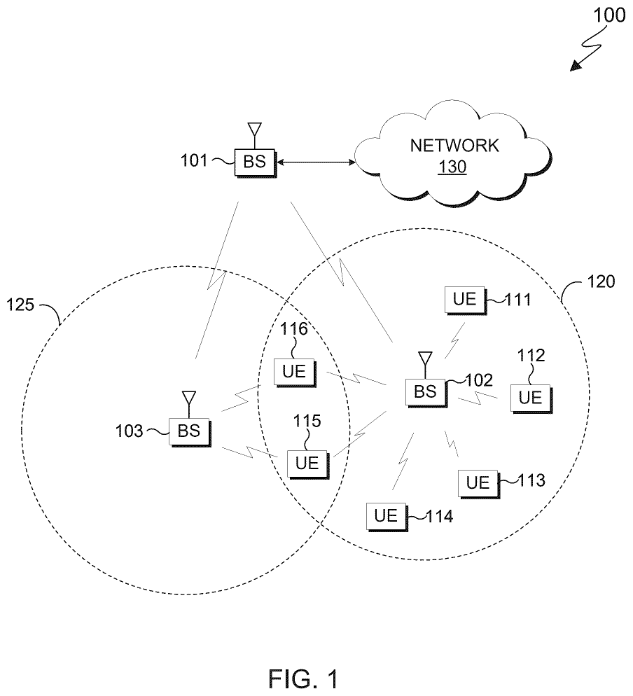

FIGS. 1-28 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v18.5.0, “NR; Physical channels and modulation” (herein, “REF 1”); 3GPP TS 38.212 v18.5.0, “NR; Multiplexing and Channel coding” (herein, “REF 2”); 3GPP TS 38.213 v18.5.0, “NR; Physical Layer Procedures for Control” (herein, “REF 3”); 3GPP TS 38.214 v18.5.0, “NR; Physical Layer Procedures for Data” (herein, “REF 4”); 3GPP TS 38.321 v18.4.0, “NR; Medium Access Control (MAC) protocol specification” (herein, “REF 5”); and 3GPP TS 38.331 v18.4.0, “NR; Radio Resource Control (RRC) Protocol Specification” (herein, “REF 6”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, eNB, gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing UE initiated UL transmissions. In certain embodiments, one or more of the BSs 101-103 include circuitry, programing, or a combination thereof to support UE initiated UL transmissions.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

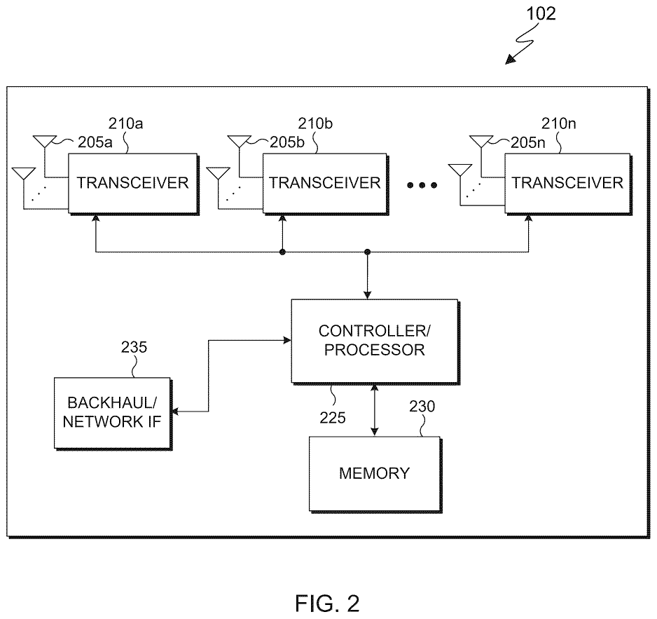

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for UE initiated UL transmissions. Any of a wide variety of other functions could be supported in the BS 102 by the controller/processor 225.

The controller/processor 225 is also capable of executing programs and other processes resident in the memory 230, such as processes to support UE initiated UL transmissions. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

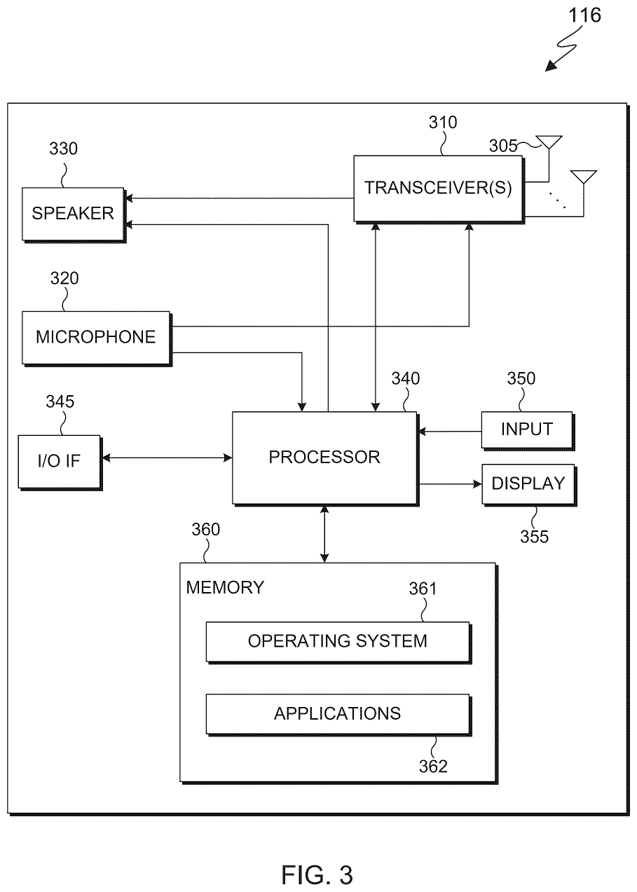

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for performing UE initiated UL transmissions as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

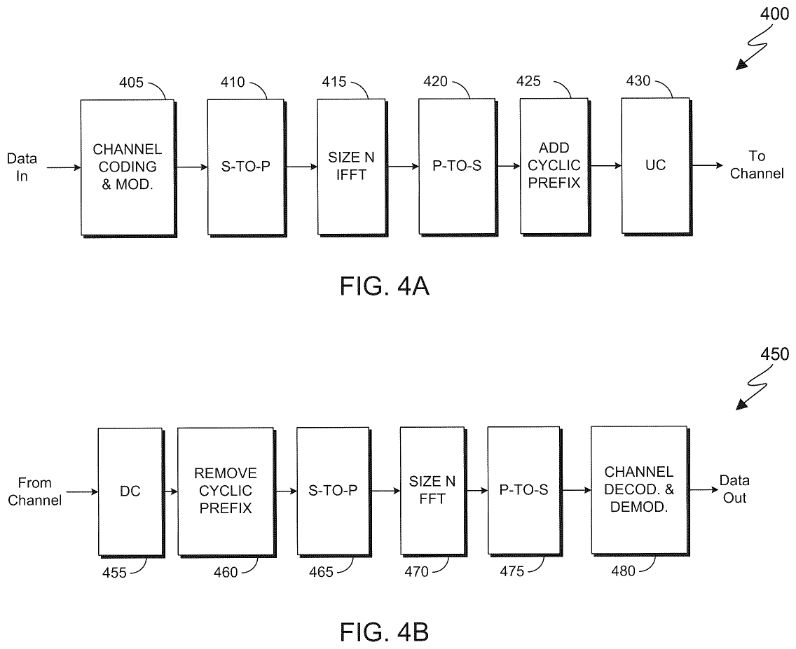

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting UE initiated UL transmissions as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In the present disclosure and in general, a time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

DL signals include data signals conveying information content, control signals conveying DL control information (DCI), and reference signals (RS) that are also known as pilot signals. A BS transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a PUSCH transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in REF 2, are referred for brevity as a unicast DCI format. A DCI format scheduling PDSCH reception for multicast communication, such as a DCI format with CRC scrambled by G-RNTI/G-CS-RNTI as described in REF 2, are referred to as multicast DCI format. DCI formats providing various control information to at least a subset of UEs in a serving cell, such as DCI format 2_0 in REF 2, are referred to as group-common (GC) DCI formats.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The BS can configure the UE to receive signals on a cell within a DL bandwidth part (BWP) of the cell DL BW.

A BS transmits one or more of multiple types of RS including channel state information RS (CSI-RS) and demodulation RS (DMRS)—see also REF 1. A CSI-RS is primarily intended for UEs to perform measurements and provide channel state information (CSI) to a BS. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used (see also REF 3). A CSI process includes NZP CSI-RS and CSI-IM resources. A UE can determine CSI-RS transmission parameters through DL control signaling or higher layer signaling, such as radio resource control (RRC) signaling from a BS (see also REF 5). Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UCI, DMRS associated with data or UCI demodulation, sounding RS (SRS) enabling a BS to perform UL channel measurement, and a random access (RA) preamble enabling a UE to perform random access (see also REF 1). A UE transmits data information or UCI through a respective physical UL shared channel (PUSCH) or a physical UL control channel (PUCCH). A PUSCH or a PUCCH can be transmitted over a variable number of slot symbols including one slot symbol. The BS can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in its buffer, link recovery request (LRR) for beam failure recovery, and CSI reports enabling a BS to select appropriate parameters for PDSCH or PDCCH transmissions to a UE. UCI also includes beam measurement reports and associated control channel signaling (UE initiated report indicator (UEIRI)) the presence of a beam measurement report. HARQ-ACK information can be configured to be with a smaller granularity than per TB and can be per data code block (CB) or per group of data CBs (CBG) where a data TB includes a number of data CBs or CBGs.

A CSI report can include a single part, or for two parts (e.g., part 1 CSI and part 2 CSI). HARQ-ACK information can be configured to be with a smaller granularity than per TB and can be per data code block (CB) or per group of data CBs where a data TB includes a number of data CBs or CBGs. A CSI report from a UE can include a channel quality indicator (CQI) informing a BS of a largest modulation and coding scheme (MCS) for the UE to detect a data TB with a predetermined block error rate (BLER), such as a 10% BLER (see also REF 3), of a precoding matrix indicator (PMI) informing a BS how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A BS can use a DMRS to demodulate information in a respective PUSCH or PUCCH. SRS is transmitted by a UE to provide a BS with an UL CSI and, for a TDD system, an SRS transmission can also provide a PMI for DL transmission. Additionally, in order to establish synchronization or an initial higher layer connection with a BS, a UE can transmit a physical random access channel (PRACH, see also REF 3 and REF 4).

SL signals and channels are transmitted and received on sub-channels within a resource pool, where a resource pool is a set of time-frequency resources used for SL transmission and reception within a SL BWP. SL channels include physical SL shared channels (PSSCHs) conveying data information, physical SL control channels (PSCCHs) conveying SL control information (SCI) for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs, PSFCH can also carry conflict information, and physical SL Broadcast channel (PSBCH) conveying system information to assist in SL synchronization. SL signals include demodulation reference signals DM-RS that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. The SCI can be split into two parts/stages corresponding to two respective SCI formats; the first SCI format is multiplexed on a PSCCH, while the second SCI format is multiplexed along with SL data on a PSSCH that is transmitted in physical resources indicated by the first SCI format.

The channel coding used to encode information presented to the physical layer depends on the type of information transmitted. Higher layer data uses LDPC coding, while control information uses Polar coding, or Reed-Muller coding for small codeblocks of size 11 bits or less.

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located (QCL) with respect to Doppler shift, Doppler spread, average delay, delay spread, and, when applicable, spatial Rx parameters. The UE may assume that the PDSCH DM-RS within the same code division multiplexing (CDM) group is QCL with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi-co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi-co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a medium access control-control element (MAC-CE) activation command to map up to [N](e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot.

In this disclosure, a beam can be determined by any of:
A TCI state, that establishes a quasi-colocation (QCL) relationship or spatial relation between a source reference signal (e.g. SSB and/or CSI-RS) and a target reference signal.
A spatial relation information that establishes an association to a source reference signal, such as SSB or CSI-RS or SRS.
   In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the BS, or a spatial Rx filter for reception of uplink channels at the BS.

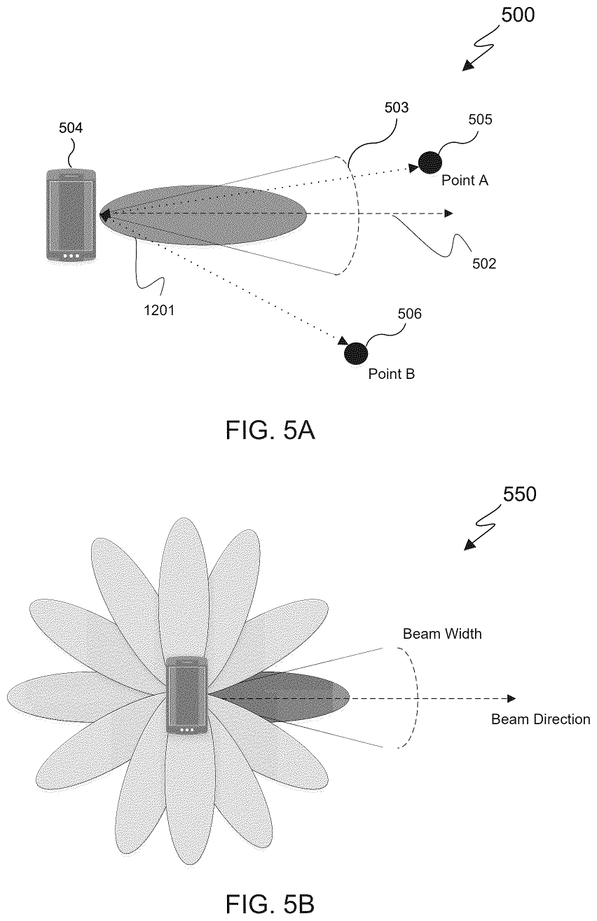

FIG. 5A illustrates an example beam operation 500 in a wireless communication system according to embodiments of the present disclosure. For example, beam operation 500 can be implemented by BS 102 and/or any of the UEs 111-116 of FIG. 1. This example is for illustration only and other embodiments can be used without departing from the scope of the present disclosure.

As illustrated in FIG. 5A, in a wireless system, a beam (501), for a device (504), can be characterized by a beam direction (502) and a beam width (503). For example, a device (504) transmits radio frequency (RF) energy in a beam direction and within a beam width. A device (504) receives RF energy in a beam direction and within a beam width. As illustrated in FIG. 5A, a device at point A (505) can receive from and transmit to device (504) as Point A is within a beam width and direction of a beam from device (504). As illustrated in FIG. 5A, a device at point B (506) cannot receive from and transmit to device (504) as Point B is outside a beam width and direction of a beam from device (504). While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example multi-beam operation 550 in a wireless communication system according to embodiments of the present disclosure. For example, multi-beam operation 550 can be implemented by BS 102 and/or any of the UEs 111-116 of FIG. 1. This example is for illustration only and other embodiments can be used without departing from the scope of the present disclosure.

As illustrated in FIG. 5B, in a wireless system, a device can transmit and/or receive on multiple beams. This is known as “multi-beam operation.” While FIG. 5B, for illustrative purposes, shows beams in 2D, it should be apparent to those skilled in the art, that beams can be 3D, where the beams can be transmitted to or received from any direction in space.

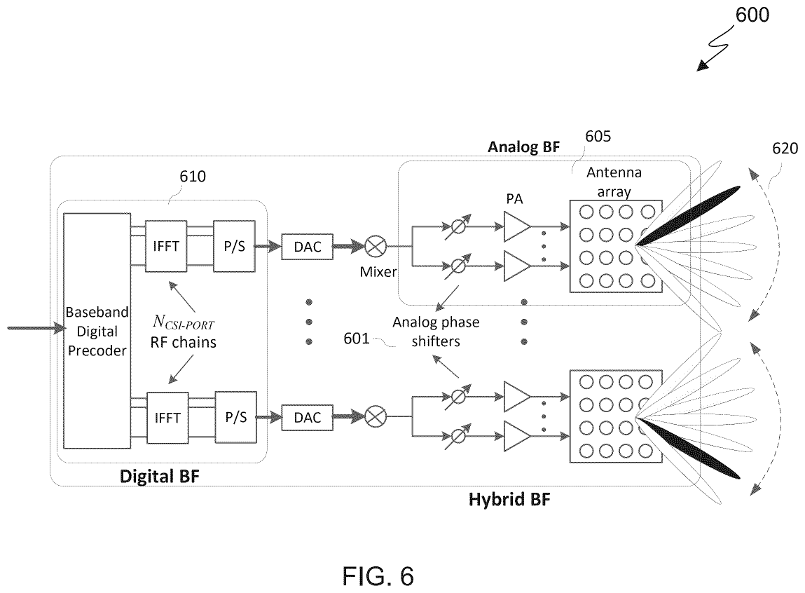

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [REF 4—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state (TCI state code point) indicated in a DL related DCI format is applied after a beam application time from the corresponding HARQ-ACK feedback.

The UL control information UCI, can be multiplexed on physical uplink control channel (PUCCH). There are 5 PUCCH formats, depending of the length of the PUCCH format (number of symbols of the PUCCH format), and the UCI payload size as illustrated in Table 1 below.

TABLE 1

| | UCI payload 1 | UCI payload |
|---|---|---|
| | or 2 bit | more than 2 bits |
| PUCCH length 1 or 2 | PUCCH Format 0 | PUCCH Format 2 |
| symbols | | |
| PUCCH length 4 to 14 | PUCCH Format 1 | PUCCH Format 3 or 4 |
| symbols | | |

PUCCH Format 4, has 1 PRB, and multiplex 2 or 4 users on the same physical resource using different spreading codes.

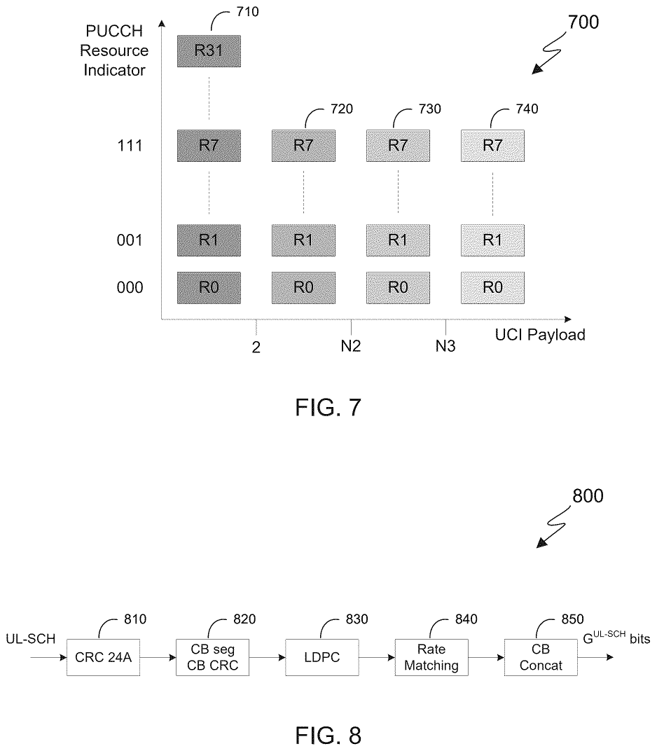

FIG. 7 illustrates a diagram 700 of example PUCCH resource sets that can be configured by the network according to embodiments of the present disclosure. For example, the PUCCH resource sets of diagram 700 can be implemented by any of the UEs 111-116 of FIG. 1. These examples are for illustration only and other embodiments can be used without departing from the scope of the present disclosure.

As illustrated in FIG. 7, the network can configure four PUCCH resource sets 710-740, where each PUCCH resource set is associated with a UCI payload size. The first PUCCH resource set 710 is used for payload size≤2 bits and can have up to 32 PUCCH resources. The second PUCCH resource set 720 is used for 2<payload size≤N₂. The third PUCCH resource set 730 is used for N₂<payload size≤N₃. The fourth PUCCH resource set 730 is used for payload size>N₃. Each of the second, third, and fourth PUCCH resource sets (720-740) can have 8 PUCCH resources. In various embodiments, a PUCCH resource is determined by PUCCH resource index (PRI), channel control element (CCE) index (when payload size is 1 or 2 bits) and payload size.

When the CSI report is a single part, the UE multiplexes the HARQ-ACK information, the scheduling request, and the CSI information into a single UCI message. This message is then encoded, rate-matched, scrambled, modulated and mapped to the resource elements of PUCCH not used for DMRS. When the CSI report has two parts (i.e., a first part CSI and a second part CSI), the first part UCI information includes HARQ-ACK information, scheduling request, and first part CSI. The second part UCI information includes second part CSI. The mapping of UCI information to PUCCH resource element is performed as follows:
First, the first part UCI information is mapped to PUCCH OFDM symbols that are closest to DMRS symbols.
Next, the second part UCI information is mapped to the remaining PUCCH resource elements.

When a PUCCH transmission overlaps with a PUSCH transmission, the UCI information is multiplexed onto the PUSCH channel:
First HARQ-ACK information is multiplexed into PUSCH starting from the first OFDM symbol after the first DMRS symbol in each frequency hop.
Next, the first part CSI is multiplexed into PUSCH starting from the first OFDM symbol of each frequency hop.
Next, the second part CSI is multiplexed into PUSCH after the first part CSI.
Finally, the transport block from higher layers is multiplexed into the remaining PUSCH resource elements not used for other purposes.

In NR, the physical uplink shared channel (PUSCH) can be used to transmit UL shared channel (UL-SCH) and UL control information (UCI).

FIG. 8 illustrates an example channel coding process 800 for an UL-SCH according to embodiments of the present disclosure. For example, channel coding process 800 can be implemented by any of the UEs 111-116 of FIG. 1. This example is for illustration only and other embodiments can be used without departing from the scope of the present disclosure.

The higher layers (e.g., MAC layer) provide up to two UL-SCH transport blocks (e.g., MAC protocol data units (PDUs)) to the physical layer within a transmission time interval (TTI). Two transport blocks are used in the case of spatial multiplexing with more than 4 layers. Each transport block is encoded and mapped to the PUSCH. As illustrated in FIG. 8, a CRC, for error detection at the receiver, is appended to the transport block (810). The transport block is segmented into multiple code blocks (CBs) and each CB has its own CB CRC (820). The low-density parity check (LDPC) code supports a maximum block size of 8424 bits for base graph 1 and 3840 bits for base graph 2, where CB segmentation allows the support of larger transport block sizes. CB-based CRC allows for code block group (CBG)-based HARQ-ACK feedback and CBG-based retransmissions, whereby only the CBGs with failed CB CRCs are retransmitted. Each CB is encoded using an error-correcting LDPC code (830). Rate matching adjusts the size of the encoded CB to fit within the resources allocated by the scheduler and further selects bits corresponding to different redundancy versions for hybrid-ARQ (840). The encoded CBs are then concatenated to provide an encoded bit stream for UL-SCH with G^{UL-SCH} bits (850).

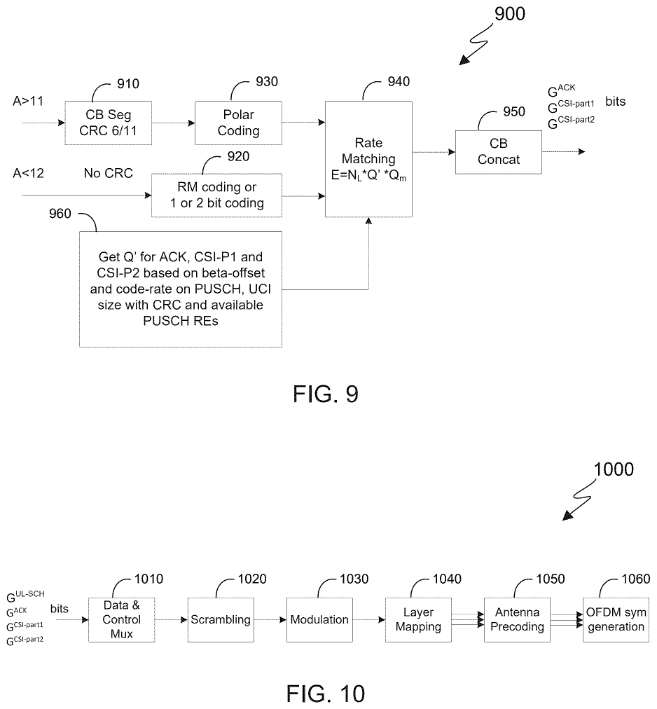

FIG. 9 illustrates an example channel coding process 900 for UCI according to embodiments of the present disclosure. For example, channel coding process 900 can be implemented by any of the UEs 111-116 of FIG. 1. This example is for illustration only and other embodiments can be used without departing from the scope of the present disclosure.

As aforementioned, there can be multiple streams of control information that are encoded separately. For example, the streams can be for HARQ-ACK information, channel state information (CSI)-part1, and CSI-part2. As illustrated in FIG. 9, for UCI blocks larger than 11 bits, a CRC is attached to the UCI payload (910). The CRC can be of size 6-bits for payloads between 12 and 19 bits and of size 11-bits for payloads larger than or equal to 20 bit. Large blocks can be segmented into multiple smaller blocks. The data is then encoded and the coding scheme used depends on the block size. Blocks of size 1 bit (c₀) are encoded as shown in Table 2 below. Blocks of size 2 bits (c₀, c₁) are encoded as shown in Table 3 below, where c₂=(c₀+c₁) mod 2. In Tables 2 and 3, “x” and “y” are placeholder bits used during scrambling to maximize the Euclidian distance of modulation symbols carrying UCI bits.

TABLE 2

| | Encoded Bits |
|---|---|
| 1 | [c₀] |
| 2 | [c₀ y] |
| 4 | [c₀ y x x] |
| 6 | [c₀ y x x x x] |
| 8 | [c₀ y x x x x x x] |

TABLE 3

| | Encoded Bits |
|---|---|
| 1 | [c₀ c₁ c₂] |
| 2 | [c₀ c₁ c₂ c₀ c₁ c₂] |
| 4 | [c₀ c₁ x x c₂ c₀ x x c₁ c₂ x x] |
| 6 | [c₀ c₁ x x x x c₂ c₀ x x x x c₁ c₂ x x x x] |
| 8 | [c₀ c₁ x x x x x x c₂ c₀ x x x x x x c₁ c₂ x x x x x x] |

With reference once again to FIG. 9, blocks with payload size between 3 and 11 bits are encoded using Reed-Muller with a 32-bit basis vector (920). Blocks larger than 11 bits use polar coding (930). Rate matching adjusts the size of the encoded data to fit within the allocated resources (940). This is then followed by CB concatenation for data that has been segmented into multiple blocks (950). The encoded bit streams for HARQ-ACK, CSI-part1 and CSI-part2 (960) have size of G^{ACK}, G^{CSI-part1}, G^{CSI-part2} bits respectively.

In various embodiments, when UL-SCH and UCI are transmitted on the same PUSCH, the UL-SCH and UCI encoded bit streams are multiplexed based on the following rules.
UCI is not multiplexed on DMRS symbols.
An RE across all layers of the same transport block is either used for UL-SCH or for a UCI type.
If frequency hopping is enabled, the UCI symbols are split equally (or almost equally) between the frequency hops.
   Improves performance with frequency diversity.
ACK is multiplexed starting from the first non-DMRS symbol after first block of DMRS symbols in each frequency hop.
   Improves performance (ACK is close to DMRS for better channel estimation).
   Reduces latency.
CSI is multiplexed starting from first non-DMRS symbols of each hop.
   Reduces latency.
Multiplexing order: (1) HARQ-ACK; (2) CSI-part 1; (3) CSI-part 2; and (4) UL-SCH
If number of HARQ-ACK bits is 0, 1 or 2 bits reserved elements are calculated assuming 2 HARQ-ACK bits.

FIG. 10 illustrates an example PUSCH process 1000 according to embodiments of the present disclosure. For example, PUSCH process 1000 may be implemented by any of the UEs 111-116 of FIG. 1. This example is for illustration only and other embodiments can be used without departing from the scope of the present disclosure.

As illustrated in FIG. 10, the PUSCH process 1000 starts with the multiplexing of UL-SCH and UCI (1010). Further, the PUSCH process 1000 may include scrambling 1020, modulation 1030, layer mapping 1040, antenna precoding 1050, and OFDM symbol generation 1060.

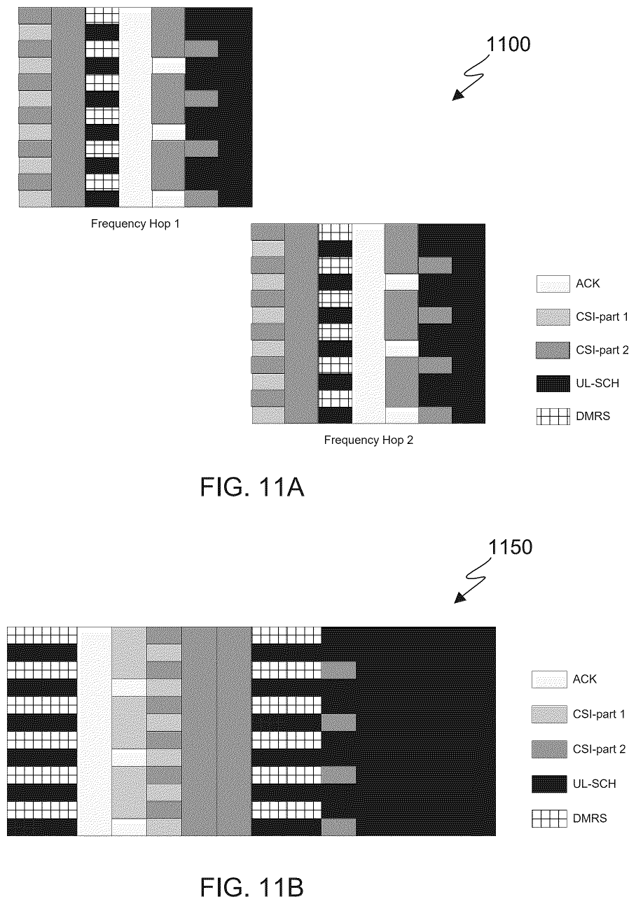

FIGS. 11A and 11B illustrate multiplexing examples 1100 and 1150, respectively, for ACK, CSI-part1, CSI-part2 and UL-SCH on a PUSCH according to embodiments of the present disclosure. For example, multiplexing examples 1100 and 1150 can be implemented by any of the UEs 111-116 of FIG. 1. FIG. 11A illustrates a multiplexing example with a non-front-end loaded DMRS and with frequency hopping. FIG. 11B illustrates a multiplexing example with a front-end loaded DMRS and without frequency hopping. These examples are for illustration only and other embodiments can be used without departing from the scope of the present disclosure.

As illustrated in FIG. 11A:
ACK bits are first mapped to the first non-DMRS symbol after the first block of DMRS symbols in each frequency hop. In the example of FIG. 11A, the ACK REs fill the REs of the first symbol after the first block of DMRS symbols in each frequency hop. Further, there are fewer remaining ACK REs than the REs of the second symbol after the first block of DMRS symbols in each frequency hop and the remaining ACK REs are disturbed within the second symbol after the first block of DMRS symbols in each frequency hop.
CSI-part1 is multiplexed starting from the first non-DMRS symbol of each frequency hop. In the example of FIG. 11A, CSI-part1 has fewer REs than the available REs in the first symbol of each frequency hop and the CSI-part1 REs are distributed within the first symbol of each frequency hop.
CSI-part2 is multiplexed starting from the first non-DMRS symbol of each frequency hop, using REs that have not been used by ACK, or CSI-part1, and not using symbols with DMRS.
The remaining REs are then used for UL-SCH.

As illustrated in FIG. 11B, and as set forth above, ACK, CSI-part1, CSI-part2 and UL-SCH can also be multiplexed on a PUSCH with a front-end loaded DMRS and without frequency hopping.

In various embodiments, the UE determines the modulation order and code rate, based on:
The MCS field in the DCI scheduling the PUSCH, or the DCI activating configured grant type-2 PUSCH, or is provided by higher layers for configured grant type-1 PUSCH.
The waveform use (CP-OFDM or DFT-S-OFDM).
The MCS tables configured for PUSCH or configured grant PUSCH, and provided in REF 4.

The UE determines the redundancy version (RV), from the RV field in the DCI scheduling the PUSCH. For configured grant type-1 and type-2 PUSCH the RV is determined as described in clause 6.1.4.1 of REF 4.

To determine the transport block size, the UE determines the number of sub-carriers in a physical resource block:

$${N}_{RE}^{′} = {N}_{sc}^{RB} \cdot {N}_{symb}^{sh} - {N}_{DMRS}^{PRB} - {N}_{oh}^{PRB} ,$$

$$where {N}_{sC}^{RB} = 12$$

is the number of resource elements in a resource block.

$${N}_{symb}^{sh}$$

is the number of PUSCH symbols.

$${N}_{DMRS}^{PRB}$$

is the number of REs for DM-RS per PRB in the allocated duration including the overhead of the DM-RS CDM groups without data.

$${N}_{oh}^{PRB}$$

is the overhead configured by higher layers, where

$${N}_{oh}^{PRB} ∈ \{ 0 , 6 , 12 , 18 \} ,$$

0 is used when no overhead is configured.

The total number of resources elements (REs) allocated to the UE is given by:

$${N}_{RE} = min ( 156 , {N}_{RE}^{′} ) \cdot {n}_{PRB} ,$$

where n_{PRB} is the total number of REs allocated to the UE.

The UE uses the determined code rate, R, modulation order, Qₘ, number of allocated MIMO layers, ν, and N_{RE} to determine the transport block size as described in steps 2-4 of clause 5.1.3.2 of REF 4.

Note that when UCI and UL-SCH are transmitted on the same PUSCH, the REs available for transmission are split between UCI and UL-SCH as described in REF 2

A transport block from higher layers includes MAC PDU, which can include one or more of:
Fixed-size MAC CE(s).
Variable size MAC CE(s).
MAC SDU(s)
Optional padding.

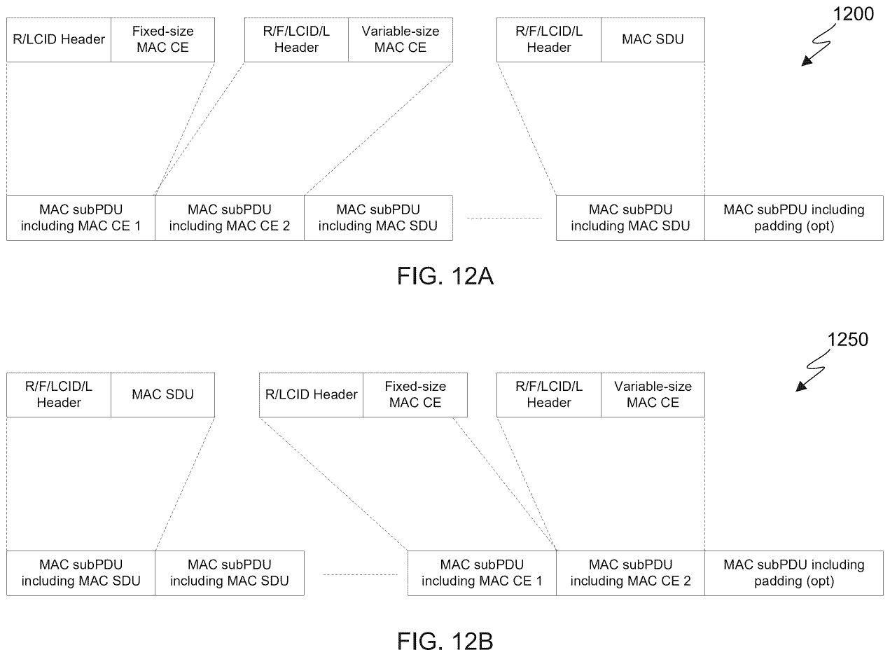

FIGS. 12A and 12B illustrate an example DL MAC PDU 1200 (e.g., transport block) and an example UL MAC PDU 1250 (e.g., transport block), respectively, according to embodiments of the present disclosure. In one example, a DL or UL transport block can include more than one DL or UL MAC PDU respectively, For example, the DL MAC PDU may be implemented by BS 102 of FIG. 1. Further, the UL MAC PDU may be implemented by any of the UEs 111-116 of FIG. 1. These examples are for illustration only and other embodiments can be used without departing from the scope of the present disclosure.

As illustrated in FIGS. 12A and 12B, DL MAC PDU 1200 and UL MAC PDU 1250 may include various MAC subPDUs, which may further include MAC CE 1, MAC CE 2, MAC SDU, or padding.

NR introduced UE initiated beam (or measurement) reporting, in Rel-19. For UE initiated beam (or measurement) reporting, a UE transmits a first UL channel alerting the network that the UE has a beam (or measurement) report, this is then followed by a second UL channel that contains the beam (or measurement) report from the UE to the network.

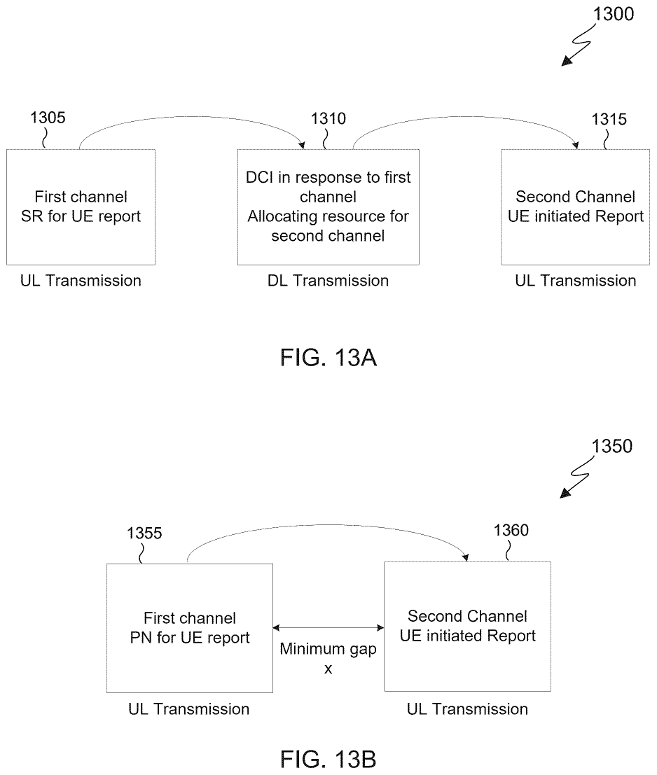

FIGS. 13A and 13B illustrate two examples of UE initiated beam (or measurement) reporting 1300 and 1350, respectively, according to embodiments of the present disclosure. For example, the UE initiated beam (or measurement) reporting 1300 and 1350 can be implemented by any of the UEs 111-116 of FIG. 1 and supported by BS 102 of FIG. 1. These examples are for illustration only and other embodiments can be used without departing from the scope of the present disclosure.

The two types of UE initiated beam (or measurement) reporting 1300 and 1350 are referred to as Mode-A (i.e. reporting 1300) and Mode-B (i.e., reporting 1350). In Mode-A, as illustrated in FIG. 13A, the first UL channel is a scheduling request (1305). In response to the scheduling request, the network transmits a DCI that schedules an UL transmission (e.g., PUSCH) for the transmission of beam (or measurement) report (1310). The measurement report is transmitted as UCI information on the UL transmission (e.g., PUSCH) (1315). The first channel can be a PUCCH, for example, a Format 0 PUCCH or Format 1 PUCCH. The second channel can be a PUSCH and the UE initiated reporting can be carried in a UCI on PUSCH (dynamic grant (DG) PUSCH).

In Mode-B, as illustrated in FIG. 13B, the first UL channel is a pre-notification (PN) of an upcoming transmission with a UE initiated reported (1355). The first UL channel is followed by a second UL channel that includes the UE initiated report (1360). There is a minimum gap (e.g., in number of slots) between the first UL channel and the second UL channel. The second UL channel can be a configured grant PUSCH (CG PUSCH). The first channel can be a PUCCH, for example, a Format 0 PUCCH or Format 1 PUCCH. The second channel can be a PUSCH and the UE initiated reporting can be carried in a UCI on PUSCH (CG PUSCH).

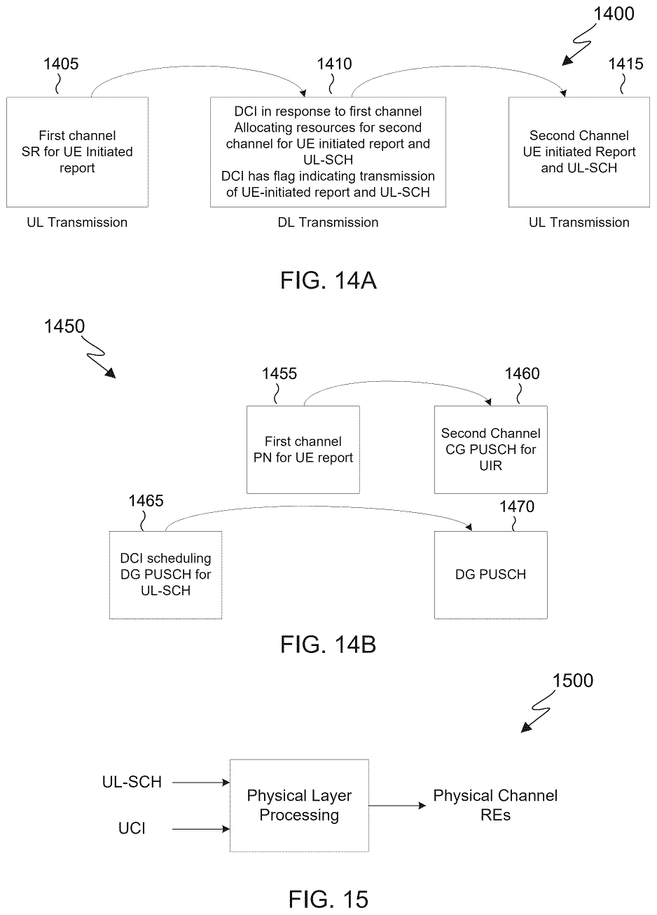

FIGS. 14A and 14B illustrate two alternative examples of UE initiated beam (or measurement) reporting 1400 and 1450, respectively, according to embodiments of the present disclosure. For example, the UE initiated beam (or measurement) reporting 1400 and 1450 can be implemented by any of the UEs 111-116 of FIG. 1 and supported by BS 102 of FIG. 1. These examples are for illustration only and other embodiments can be used without departing from the scope of the present disclosure.

The two alternative types of UE initiated beam (or measurement) reporting 1400 and 1450 are referred to as Mode-A (i.e. reporting 1400) and Mode-B (i.e., reporting 1450). In various embodiments, if the UE has other data to transmit (e.g., user data on UL-SCH), and the UE wants to transmit a UE-initiated report, there can be a collision between the UL initiated report and the UL-SCH. For Mode-A, as illustrated in FIG. 14A, when the BS receives the first channel carrying the SR for the UE initiated report (1405) and UL-scheduler in the BS wants to schedule an uplink transmission for UL-SCH, the BS can transmit a DCI for the UE initiated report and UL-SCH (1410). The DCI Format can indicate (e.g., through a flag) for the UE to transmit the UE initiated report, e.g., on UCI, as well as the UL-SCH (1415). In one example the UE initiated report is a beam report. In one example, the UE initiated report is a CSI report. In one example, the UE initiated report is a report of mobility measurements (e.g., measurement of RSRP of other (candidate) cells).

For Mode-B, a UE is configured UL resources (e.g., PUSCH, CG PUSCH, or PUCCH) for UE initiated reporting. UE initiated reporting can include, for example, channel state information (CSI) reporting, beam reporting, and/or mobility measurements (e.g., measurement of RSRP of other (candidate) cells). As illustrated in FIG. 14B, the UE transmits a first channel (e.g., pre-notification signal) using, for example, PUCCH (e.g., PUCCH Format 0 or PUCCH Format 1) (1455) before transmitting on corresponding configured UL resources for UE initiated reporting, referred to as CG PUSCH for UE initiated report (UIR) (1460). A DCI schedules a dynamic grant PUSCH (DG PUSCH) (1465) and the DG PUSCH (1470) overlaps with CG PUSCH for UIR. In one example, the overlapping can be in time domain. In one example, the overlapping can be in time and frequency domain.

The present disclosure considers, among other things, how to resolve the collision between an overlapping PUSCH for a UE initiated report and a dynamically scheduled PUSCH. In addition, the following aspects are considered:
Dropping or multiplexing rules for overlapped PUSCH reporting UE initiated report and dynamically scheduled PUSCH.
Multiple PUSCH configurations for multiplexing UCI payloads with different UCI payload size. The PUSCH configuration used can be based on indication from the UE.
Timing requirements of dynamically scheduled PUSCH and corresponding DCI.

Further in NR, as introduced above, the PUSCH can be used to transmit UL-SCH and UCI. As aforementioned, FIG. 8 illustrates the channel coding for UL-SCH, FIG. 9 illustrates the channel coding for UCI where multiple streams of UCI can be separately encoded and multiplexed, and FIG. 10 illustrates that when UL-SCH and UCI are transmitted on the same PUSCH, the UL-SCH and UCI encoded bit streams are multiplexed.

Different UCI Types can have different error rate protection requirements or targets. One way to achieve different error rates for the different UCI types is to have different beta offset values for the different UCI types, which leads to different code rates for the different UCI types multiplexed on the same channel. Another method to have different error protection requirements is to map UCI types with more error protection requirements (e.g., lower error rate) to be closer to the DMRS symbols. While these methods can achieve different error rate protection targets for the different UCI types it increases design complexity. An alternative scheme is to exploit the fact that bits at the input to the channel encoder have different reliability. UCI-Types with tighter error protection targets are mapped to more reliable bits at the input to the channel encoder.

This disclosure considers, among other things, mapping various UCI types to channel encoder input based on the reliability requirements of UCI Types. More particularly, this disclosure considers aspects related to multiplexing of UL control information (UCI) onto UL physical channels, where UCI is of different Types (e.g., HARQ-ACK, CSI-part1, CSI-part2, etc.), and different UCI types have different error protection requirements or targets. In addition, this disclosure includes the following:
Three levels of multiplexing different UCI-Types.
First level: bit level multiplexing before CRC.
Second level: bit level multiplexing after CRC.
Third level: Multiplexing after channel encoding and rate matching.
Multiplexing of UCI at the input of the encoder based on target error protection level and bit-reliability at the input to the encoder.
Multiplexing UCI into multiple UL-SCH code blocks.

In the following, both FDD and TDD are considered as a duplex method for DL and UL signaling. In addition, full duplex (XDD) operation is possible, e.g., sub-band full duplex (SBFD) or single frequency full duplex (SFFD).

Although descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure considers several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE and can be UE common (e.g., to a group of UEs). MAC CE signaling can be DL MAC CE signaling or UL MAC CE signaling.

In this disclosure L1 control signaling includes: (1) DL control information (e.g., DCI on PDCCH or DL control information on PDSCH or a sequence-based signal) and/or (2) UL control information (e.g., UCI on PUCCH or PUSCH). L1 control signaling be UE-specific e.g., to one UE and can be UE common (e.g., to a group of UEs or to all UEs in a cell).

In this disclosure, configuration can refer to configuration by semi-static signaling (e.g., RRC or SIB signaling). In one example, a configuration can be applicable to multiple transmission instances, until a configuration is received and applied.

In this disclosure, indication can refer to indication by dynamic signaling (e.g., L1 control (e.g., DCI Format or sequence-based signal) or MAC CE signaling). In one example, an indication can be for an associated occasion(s) (e.g., an occasion or multiple occasions associated with the indication).

In this disclosure a list with N elements can be denoted as L(i), where i can take N values, and can correspond to the element associated with index i. In one example, i can take N arbitrary values. In one example, =0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or BS) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or BS) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as UCI, MAC CE, PUCCH, PUSCH, transport block and other terms are used for illustrative purposes and is therefore not normative. Other terms that refer to same functions can also be used.

In this disclosure, UL control information can include the following UL control information types:
HARQ-ACK for DL transport blocks.
Scheduling request (SR).
Channel state information (CSI). In one example, CSI can be a single part CSI. In another example, CSI can be a two-part CSI, e.g., a first part CSI and a second part CSI.
Link recovery request (LRR), this can be similar to SR.
Pre-notification or scheduling request for UE reporting (beam reporting or CSI reporting) introduced in 3GPP Rel-19.
UE initiated report indication (UEIRI) (introduced in 3GPP Rel-19).
Transport format indication information, e.g., indicating modulation coding scheme, and/or transport block size and/or resource allocation and/or HARQ related parameters and/or MIMO related parameters of data conveyed in the UL physical channel.

In one example, the information corresponding to each of the aforementioned UL control information types can be transmitted independently, e.g., the information for each UL control information type is separately encoded and multiplexed or mapped onto the physical UL channel e.g., PUSCH or PUCCH.

In another example, information corresponding to each of the aforementioned UL control information types can be first multiplexed, and then jointly encoded, rate-matched, scrambled and/or modulated and mapped to resource elements of the corresponding physical UL channel. For example, in NR, when CSI has one part, the HARQ-ACK, SR and CSI information are multiplexed, and jointly pass through the encoding and transmission stages and are transmitted on PUCCH.

In another example, the UL control information (UCI) types are divided into groups, where information corresponding to each group of UL control information types can be first multiplexed, and then jointly encoded, rate-matched, scrambled and/or modulated and mapped to resource elements of the corresponding physical UL channel. For example, in NR, when CSI has two parts, the HARQ-ACK, SR and CSI information are multiplexed to give a first part of UCI, and jointly pass through the encoding and transmission stages and are transmitted on PUCCH. The second part CSI can be separately encoded and mapped to the remaining PUCCH resources. UL control information types that are multiplexed together and jointly encoded and transmitted can have similar transport characteristics.

In the present disclosure, UCI is transmitted in an uplink physical channel (e.g., physical uplink shared channel (PUSCH) or physical uplink control channel (PUCCH)).

In one example, a PUSCH can be scheduled or allocated dynamically, e.g., PUSCH is scheduled by a DCI Format (e.g., UL related DCI Format, e.g., in NR, DCI Format 0_0 or DCI Format 0_1 or DCI Format 0_2, . . . ). In various embodiments, the UL related DCI Format can indicate, (1) the time and frequency resources of PUSCH, (2) the modulation coding scheme (MCS) of the PUSCH, which determines the modulation order and the code rate of the transmission and can determine the transport block size with the amount of time and frequency resources, (3) HARQ related information such as HARQ process number, redundancy version (RV), and new data indicator, the DCI Format can also indicate, the rank of the PUSCH transmission, and precoding related information including SRS related information.

In one example, the PUSCH can be allocated semi-statically, e.g., by higher layer (for example RRC) signaling. In various embodiments, the RRC configuration can indicate, (1) the time and frequency resources of PUSCH including periodicity/offset of PUSCH occasions, (2) the modulation coding scheme (MCS) of the PUSCH, which determines the modulation order and the code rate of the transmission and can determine the transport block size based on the amount of time and frequency resources, (3) rank and precoding related information including SRS related information.

In one example, the semi-static PUSCH can be PUSCH configured grant Type 1 (CG Type1), wherein the PUSCH becomes active when configured.

In one example, the semi-static PUSCH can be PUSCH configured grant Type 2 (CG Type2), wherein RRC signaling configures the PUSCH, additional dynamic signaling (e.g., L1 control (DCI Format), or MAC CE signaling) can further activate or deactivate the configured PUSCH occasions to use or not to use respectively, and can optionally update the configuration of the configured PUSCH. In one example, the configuration of the configured PUSCH (e.g., configured by higher layers) can include multiple configurations, e.g., a first configuration associated with a first index, a second configuration associated with a second index, and so on. In one example, the message activating the configured PUSCH can indicate one of the configurations configured by higher layers, e.g., the message activating the configured PUSCH can indicate an index corresponding to the configuration used.

FIG. 15 illustrates an example diagram 1500 of physical layer processing according to embodiments of the present disclosure. For example, the physical layer processing can be implemented by any of the UEs 111-116 or BS 102 of FIG. 1. This example is for illustration only and can be used without departing from the scope of the present disclosure.

In one example, as illustrated in FIG. 15, the following information is presented to physical layer for encoding, modulation and transmission:
UL control information (UCI), wherein UCI can be according to the aforementioned types. In one example, each UCI type has a bit stream. In one example, a UCI type can have multiple bit streams, for example for CSI, there can be CSI-part1 and CSI-part2. In one example, there are multiple bit streams, and a bit stream can include one or more UCI types, for example, a first bit stream for HARQ-ACK and CSI-part1, and a second bit stream for CSI-part2. In one example, there is one-bit stream for UCI multiplexed on PUSCH, e.g., UCI information (e.g., HARQ-ACK and/or CSI) is multiplexed into one-bit stream. In one example, the size of the UCI payload for each type can vary for example, depending on the channel conditions.
UL shared channel (UL-SCH). In one example, UL-SCH is one transport block (e.g., when the number of spatial layers is 1 to 4). In one example, UL-SCH is two transport blocks (e.g., when the number of spatial layers is 5 to 8).

As aforementioned and illustrated in FIG. 14B, Mode-B of UE initiated reporting, a CG PUSCH for UE initiated (UEI) report can overlap with a DG PUSCH that is dynamically scheduled by the network. In one example, the overlapping can be in time domain. In one example, the overlapping can be in time and frequency domain.

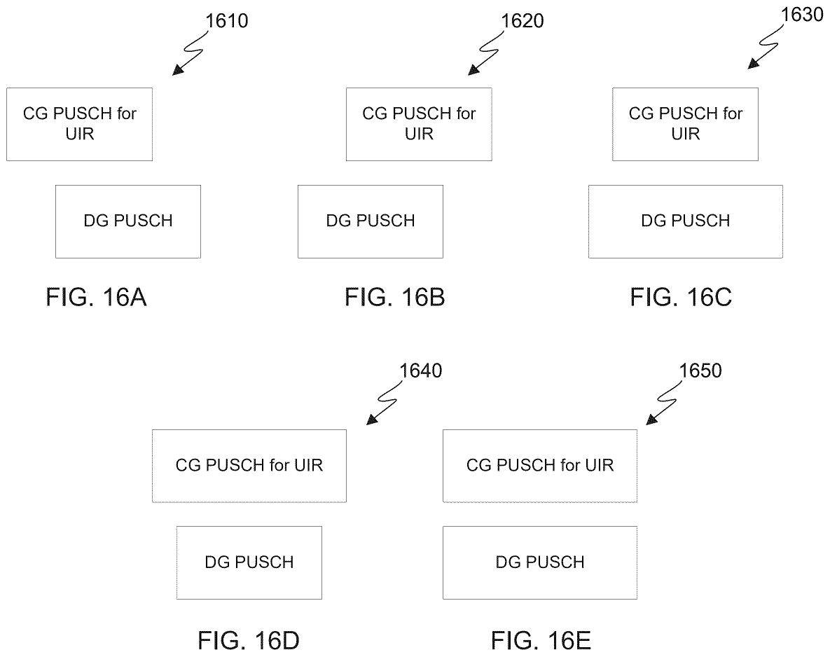

FIGS. 16A-16E illustrate further examples of overlapping UE initiated reporting 1610-1650, respectively, according to embodiments of the present disclosure. For example, the UE initiated reporting 1610-1650 can be implemented by any of the UEs 111-116 of FIG. 1 and supported by BS 102 of FIG. 1. These examples are for illustration only and other embodiments can be used without departing from the scope of the present disclosure.

In one example, as illustrated in FIGS. 16A-16D, the overlap in time domain can be a partial overlap, wherein the CG PUSCH for UEI report can overlap in some symbols, but there are other symbols where only CG PUSCH for UEI report is transmitted or where only DG PUSCH is transmitted.

In one example, as illustrated in FIG. 16E, the overlap in time domain can be a full overlap, wherein the CG PUSCH for UEI report can overlap in all symbols.

In one example, the overlap in time and frequency domains can be partial overlap, wherein the CG PUSCH for UEI report can overlap in some resource elements, but there are other resource elements where only CG PUSCH for UEI report can be transmitted or where only DG PUSCH can be transmitted.

In one example, the overlap in time and frequency domains can be full overlap, wherein the CG PUSCH for UEI report can overlap in all resource elements.

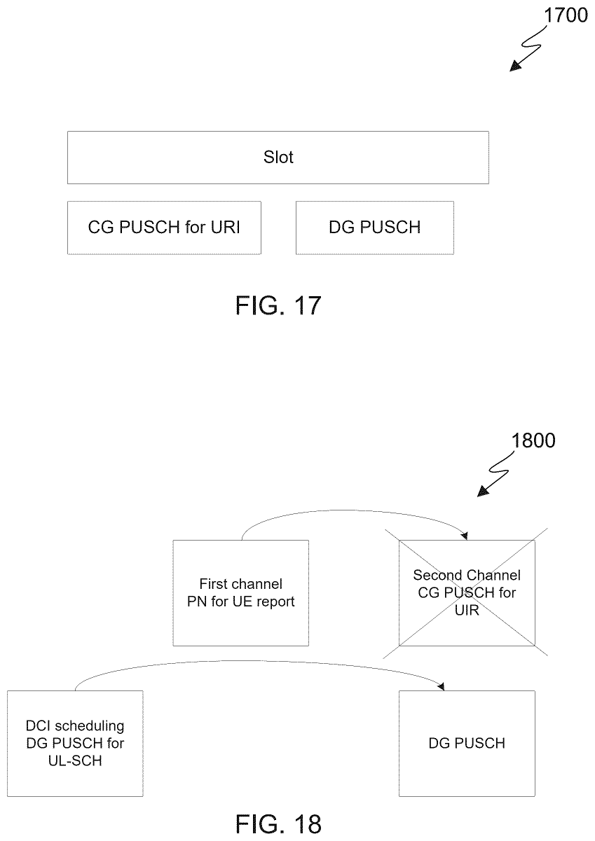

FIG. 17 illustrates an example of UE initiated reporting 1700 according to embodiments of the present disclosure. For example, the UE initiated reporting 1700 can be implemented by any of the UEs 111-116 of FIG. 1 and supported by BS 102 of FIG. 1. This example is for illustration only and other embodiments can be used without departing from the scope of the present disclosure.

In various embodiments, a DG PUSCH and CG PUSCH for UIR in a same slot are considered to be overlapping, and the examples for handling overlapping DG PUSCH and CG PUSCH for UIR can apply, whether or not they overlap in time domain or whether or not they overlap in time and frequency domains. FIG. 17 illustrates an example of a DG PUSCH and CG PUSCH for UIR that are in the same slot, but do not overlap on any symbols. In one example, these can be considered as overlapping or colliding channels for the purpose of multiplexing or dropping as described herein.

In one example, DG PUSCH and CG PUSCH for UIR have a same sub-carrier spacing and the slot is with respect to that sub-carrier spacing. In one example, DG PUSCH and CG PUSCH for UIR have different sub-carrier spacing and the slot is with respect to the slot with minimum sub-carrier spacing of DG PUSCH and CG PUSCH for UIR. In one example, DG PUSCH and CG PUSCH for UIR have different sub-carrier spacing and the slot is with respect to the slot with maximum sub-carrier spacing of DG PUSCH and CG PUSCH for UIR. In one example, DG PUSCH and CG PUSCH for UIR have different sub-carrier spacing and the slot is with respect to the slot of DG PUSCH. In one example, DG PUSCH and CG PUSCH for CSI have different sub-carrier spacing and the slot is with respect to the slot of CG PUSCH for UIR.

In one example, CG PUSCH for UIR is a Type-1 CG PUSCH, e.g., the CG PUSCH is configured by higher layers (e.g., RRC signaling and/or SIB signaling).

In one example, CG PUSCH for UIR is a Type-2 CG PUSCH, e.g., the CG PUSCH is configured by higher layers (e.g., RRC signaling and/or SIB signaling), can be activated and/or deactivated by dynamic signaling e.g., L1 signaling (e.g., DCI format) or MAC CE signaling. In one example, the Type-2 CG PUSCH is activated for N instances of CG PUSCH, after the N instances the CG PUSCH transmissions stop, without further signaling. In one example, the quantity N is configured by the network (e.g., by SIB or RRC signaling). In one example, the quantity N is indicated in the message activating the Type-2 CG PUSCH. In one example, the time between an instance of CG PUSCH and a next instance of CG PUSCH is T.

In one example, there is no UE initiated report on the CG PUSCH for UIR resources. The UE doesn't transmit PN for CG PUSCH for UIR. The UE transmits DG PUSCH following the DCI that scheduled the DG PUSCH.

In one example, there is a UE initiated report on the CG PUSCH for UIR resources, and the CG PUSCH for UIR collides with or overlaps with DG PUSCH according to the aforementioned examples.

FIGS. 18-21 illustrate examples of UE initiated reporting 1800-2100 that handle the overlap or collision between DG PUSCH and CG PUSCH for UIR according to embodiments of the present disclosure. For example, the UE initiated reporting 1800-2100 can be implemented by any of the UEs 111-116 of FIG. 1 and supported by BS 102 of FIG. 1. This example is for illustration only and other embodiments can be used without departing from the scope of the present disclosure.

In one example, the UE drops CG PUSCH for UIR and transmits DG PUSCH based on the DCI scheduling the DG PUSCH.

In one example, as illustrated in FIG. 18, the UE drops CG PUSCH for UIR and transmits DG PUSCH based on the DCI scheduling the DG PUSCH. The UE transmits the PN for the CG PUSCH for UIR, the PN can be used as a scheduling request for a future DCI-scheduled PUSCH for UEI reporting. In response to the PN, the BS can send a DCI to schedule PUSCH for UE initiated report with UL-SCH or without UL-SCH.

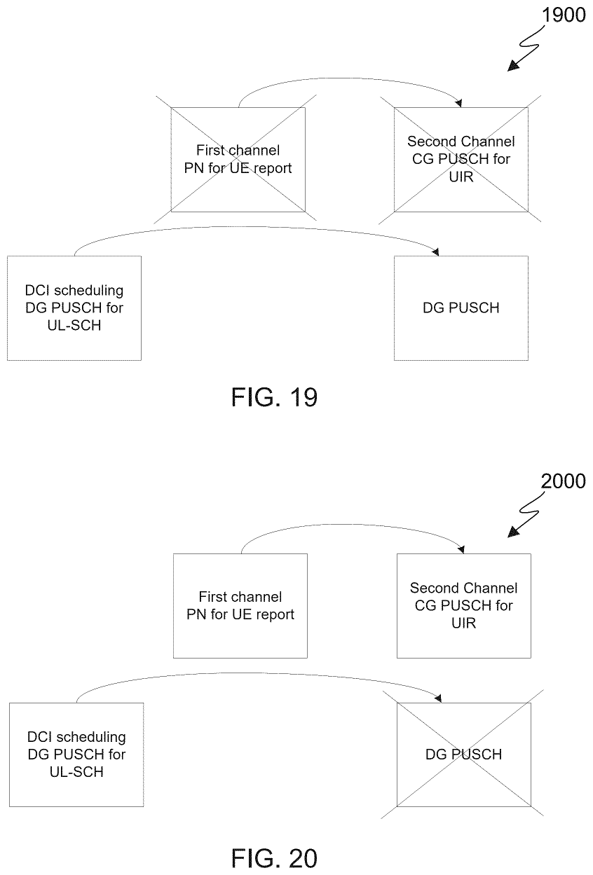

In one example, as illustrated in FIG. 19, the UE drops CG PUSCH for UIR and transmits DG PUSCH based on the DCI scheduling the DG PUSCH. The UE doesn't transmit the PN for the CG PUSCH for UIR, the UE initiated report can be deferred to a future CG PUSCH for UIR.

In one example, the UE drops CG PUSCH for UIR and transmits DG PUSCH based on the DCI scheduling the DG PUSCH. The UE can be configured or indicated whether to follow one of the examples set for above (e.g., transmit PN or not to transmit PN). In on example, the configuration or indication whether or not to transmit PN can be by a message from BS to UE, for example, the message can be SIB or RRC or MAC CE or L1 control (e.g., DCI format or sequence-based) message. In one example, the indication whether or not to transmit PN can be included in the DCI Format scheduling the DG PUSCH. In one example, for Type-2 CG PUSCH for UIR, the indication whether or not to transmit PN can be included in the signaling used to activate Type-2 CG PUSCH for UIR (e.g., L1 control (e.g., DCI Format or sequence-based) activating Type-2 CG PUSCH for UIR, or higher layer signaling (e.g., MAC CE) activating Type-2 CG PUSCH for UIR, or higher layer signaling).

In one example, as illustrated in FIG. 20, the UE drops DG PUSCH and transmits CG PUSCH for UIR. The UE transmits the PN for PUSCH for UIR. In one example, the PN can indicate to the network that associated CG PUSCH for UIR will be transmitted.

In one example, the UE can be configured or indicated whether to drop CG PUSCH for UIR and transmit DG PUSCH based on the DCI scheduling the DG PUSCH, as set forth in the examples above, or drop DG PUSCH and transmit CG PUSCH for UIR, as set forth in the examples above. In one example, the configuration or indication whether to transmit DG PUSCH and drop CG PUSCH for UIR or transmit CG PUSCH for UIR and drop DG PUSCH can be by a message from BS to UE. For example, the message can be a SIB or RRC or MAC CE or L1 control (e.g., DCI format or sequence-based) message. In one example, the indication whether to transmit DG PUSCH and drop CG PUSCH for UIR or transmit CG PUSCH for UIR and drop DG PUSCH can be included in the DCI Format scheduling the DG PUSCH. In one example, for Type-2 CG PUSCH for UIR, the indication whether to transmit DG PUSCH and drop CG PUSCH for UIR or transmit CG PUSCH for UIR and drop DG PUSCH can be included in the signaling used to activate Type-2 CG PUSCH for UIR (e.g., L1 control (e.g., DCI Format or sequence-based) activating Type-2 CG PUSCH for UIR, or higher layer signaling (e.g., MAC CE) activating Type-2 CG PUSCH for UIR, or higher layer signaling).

In one example, the UE transmits a PUSCH and the PUSCH includes the UE initiated report and UL-SCH.

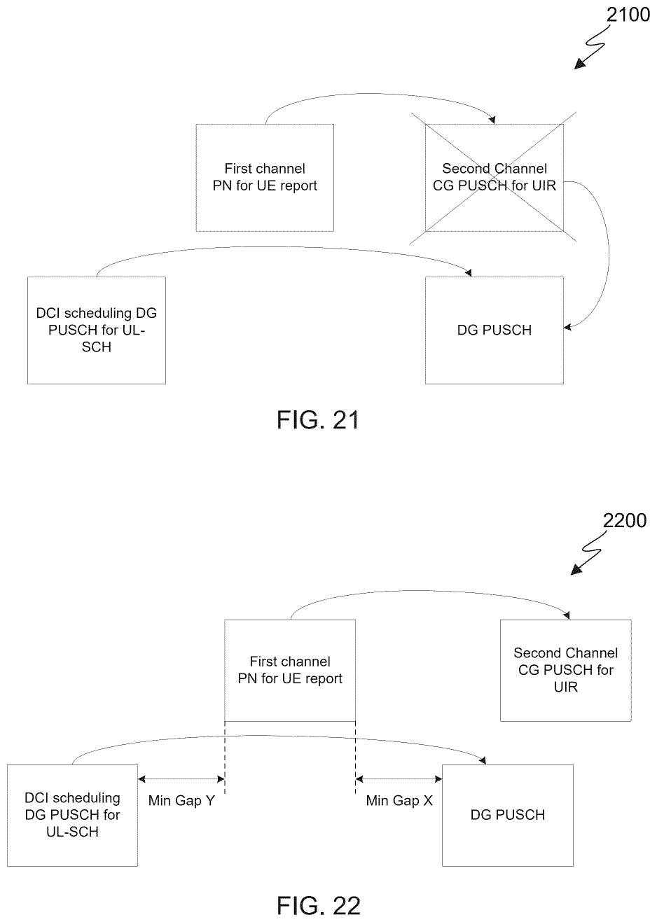

In one example, as illustrated in FIG. 21, the PUSCH transmitted by the UE is the PUSCH scheduled by DCI (e.g., using the resources indicated in the DCI scheduling DG PUSCH).

In one example, the PUSCH transmitted by the UE is the PUSCH scheduled by of CG PUSCH for UIR (e.g., using the resources configured in the CG PUSCH for UIR).

In one example, the UE transmits a PUSCH (e.g., DG-PUSCH or CG-PUSCH) and the PUSCH includes the UE initiated report and UL-SCH. The UE transmits the PN for the CG PUSCH for UIR, for example the PN can indicate that the UE initiated report is multiplexed in the PUSCH. In one example, the PN can indicate multiple values, the value indicated by the PN indicates the amount of UE initiated report payload being multiplexed on PUSCH. In one example, the configuration of the transmitted PUSCH is determined as described in the following.

In one example, the UE transmits a PUSCH (e.g., DG-PUSCH or CG-PUSCH) and the PUSCH includes the UE initiated report and UL-SCH. The UE does not transmit the PN for the CG PUSCH for UIR, the UE can includes in the PUSCH an indicator to indicate whether or not the UEI report is being multiplexed on PUSCH. In one example, the indicator can be based on a PUSCH DMRS pattern, a first PUSCH DMRS pattern is used if there are no UE initiated report multiplexed in PUSCH, and a second PUSCH DMRS pattern is used if there is a UE initiated report multiplexed in PUSCH. In one example, an indicator is separately multiplexed into PUSCH. In one example, the indicator can indicate multiple values, the value indicated by the indicator indicates the amount of UE initiated report payload being multiplexed on PUSCH. In one example, the configuration of the transmitted PUSCH is determined as described in the following.

In one example, the UE transmits a PUSCH (DG-PUSCH or CG-PUSCH) and the PUSCH includes the UE initiated report and UL-SCH. The UE does not transmit the PN for the CG PUSCH for UIR, and the UE does not transmit an indicator in PUSCH to indicate whether or not the UE initiated report and UL-SCH are multiplexed on PUSCH. In one example, the BS can decode multiple hypothesis to determine whether or not UE initiated report and UL-SCH are multiplexed on PUSCH.

In the aforementioned example, where the UE initiated report and UL-SCH can be multiplexed on PUSCH. The UE can be configured with two overhead parameters, e.g., a first overhead parameter is used when the UE initiated report is not multiplexed on PUSCH, and a second overhead parameter is used when the UE initiated report is multiplexed on PUSCH. In variant example, there can be multiple overhead parameters configured, e.g., a first overhead parameter is used when the UE initiated report is not multiplexed on PUSCH, a second overhead parameter when the PN or the indicator in the PUSCH indicate a first UE initiated report payload size, a third overhead parameter when the PN or the indicator in the PUSCH indicate a second UE initiated report payload size, and so on.

In one example, the overhead parameter is a number of overhead REs to subtract per PRB when calculating the transport block size of the UL-SCH. In one example, the overhead parameter is a number of overhead REs to subtract across the entire PUSCH allocation when calculating the transport block size of the UL-SCH.

In one example, a UE receives a configuration for PUSCH. In one example, the configuration for PUSCH can include N configurations, e.g., N>1. In one example, each configuration can include one or more of the following:
Beta offset values, a one set of beta offset values for static beta offsets, or M (e.g., 4 or up 4) sets of beta offsets, for dynamic beta offsets.
Scaling parameter to limit the resource elements to assign to UCI, e.g., parameter alpha in clause 6.3.2 of REF 2. For example, f0p5 can be 0.5, which indicates that 0.5 of the available PUSCH REs can be used for UCI.
Overhead. In one example, the overhead is the overhead REs per PRBs used when calculating the available REs for UL-SCH and UL-SCH transport block size as aforementioned. In one example, the overhead is the overhead REs in the PUSCH used when calculating the available REs for UL-SCH and UL-SCH transport block size.
UCI payload size or CSI report payload size, multiplexed on PUSCH.
DMRS configuration (e.g., DMRS sequence).

In one example, a set of beta offset values can include:
One or more beta offset values for a first UCI type (e.g., HARQ-ACK). For example, a first beta offset value for a first UCI type with payload less than (or less than or equal to) A1. A second beta offset value for a first UCI type with payload between A1 and A2. A third beta offset value for a first UCI type with payload more than (or more than or equal to) A2 (there can be multiple ranges for the payload size) . . .
One or more beta offset values for a second UCI type (e.g., CSI-part 1). For example, a fourth beta offset value for a second UCI type with payload less than (or less than or equal to) B1. A fifth beta offset value for a second UCI type with payload more than (or more than or equal to) B1 (there can be multiple ranges for the payload size) . . .
One or more beta offset values for a third UCI type (e.g., CSI-part 2). For example, a sixth beta offset value for a third UCI type with payload less than (or less than or equal to) CL. A seventh beta offset value for a third UCI type with payload more than (or more than or equal to) C1 (there can be multiple ranges for the payload size) . . .
. . .

In one example, there are multiple sets of beta offset values and the DCI triggering DG PUSCH can indicate an index corresponding to one of these sets.

In one example, one or more of the aforementioned parameters can be common across the N PUSCH configurations.

In one example, the PN triggering can indicate an index to one of the N configurations, e.g., as described in a previous example.

In one example, the indicator included in the PUSCH, can indicate an index to one of the N configurations, e.g., as described in a previous example.

In one example, a first configuration can correspond to no UCI multiplexed on PUSCH, e.g., UCI payload size is 0.

In one example, there is no configuration corresponding to UCI being on PUSCH, a UE uses default configuration values.

In one example, a UE has a measurement report to transmit on CG PUSCH for UIR. A UE receives a DCI for DG PUSCH, and the CG PUSCH for UIR and the DG for PUSCH overlap.

In one example, the UE determines a UCI payload size and the UE determines a configuration of the N PUSCH configurations to use based on the UCI payload size. In one example, this can be based on rounding up the UCI payload size the UE has to transmit to the closest UCI payload size associated with a one of the N PUSCH configurations. In one example, this can be based on rounding the UCI payload size the UE has to transmit to the closest UCI payload size associated with one of the N PUSCH configurations.

In one example, based on the determined PUSCH configuration of the N PUSCH configuration and the UCI payload size, the UE determines the number of REs for each UCI type and the UL-SCH transport block size as aforementioned and as described in REF 2 and REF 4.

In one example, the UCI payload size transmitted on PUSCH is the UCI payload size for the report as determined by the UE.

In one example, the UCI payload size transmitted on PUSCH is a UCI payload size corresponding to the PUSCH configuration determined by the UE as aforementioned.

In one example the UE indicates a configuration of the N PUSCH configurations (or no UCI) in the PN signal transmitted by the UE.

In one example the UE indicates a configuration of the N PUSCH configurations (or no UCI) in an indicator transmitted with (in) the PUSCH.

In one example, there are not enough resources in the PUSCH for the UEI report. In one example, the UE transmits part of the UEI report. In one example, the UE transmits part of the UEI report and transmits an indicator requesting additional resources for the rest of the UEI report. In one example, the indicator can be in the PN. In one example, the indicator can be in the PUSCH. In one example, the indicator can be in the UCI multiplexed in the PUSCH. In one example, the indicator can be in a MAC CE in the PUSCH. In one example, the PUSCH configuration (of the N PUSCH configurations) selected for transmitting part of the UEI is the configuration associated with the largest UCI payload size.

In one example, there are not enough resources in the PUSCH for the UEI report. In one example, the UE does not transmit the UEI report. In one example, the UE does not transmit the UEI report and transmits an indicator requesting addition resources for the UEI report. In one example, the indicator can be in the PN. In one example, the indicator can be in the PUSCH. In one example, the indicator can be in a UCI multiplexed in the PUSCH. In one example, the indicator can be in a MAC CE in the PUSCH.

In one example, the DG PUSCH and CG PUSCH for UIR overlap in time domain, or an in a same slot as aforementioned, but do not overlap in the frequency domain. The UE can transmit DG PUSCH and CG PUSCH in parallel on the non-overlapping resources.

In one example, the DG PUSCH and CG PUSCH for UIR overlap partially overlap on some resources. In one example, the UE transmits DG PUSCH on the resources allocated to DG PUSCH by the DCI Format scheduling the DG PUSCH, and the UE transmits CG PUSCH for UIR, using the CG PUSCH for UIR resources that do not overlap with DG PUSCH.

In one example, if the available resources for CG PUSCH for UIR (e.g., resources that do not overlap with DG PUSCH), are greater than (or greater than or equal to) a threshold, the UE transmits CG PUSCH for UIR on the available resources, else the UE drops CG PUSCH for UIR. In one example, if the ratio of available resources for CG PUSCH for UIR (e.g., resources that don't overlap with DG PUSCH) to the resources of CG PUSCH for UIR, are greater than (or greater than or equal to) a threshold, the UE transmits CG PUSCH for UIR on the available resources, else the UE drops CG PUSCH for UIR. In one example, the aforementioned thresholds can be defined in the system specifications and/or configured or updated by SIB and/or RRC and/or MAC CE and/or L1 control signaling. In one example, the threshold can be signaled by the DCI Format scheduling the DG PUSCH.

In one example, if the available resources for CG PUSCH for UIR (e.g., resources that do not overlap with DG PUSCH), are greater than (or greater than or equal to) a threshold, the UE transmits CG PUSCH for UIR on the available resources (e.g., UE additionally transmits DG PUSCH), else the UE drops DG PUSCH and transmits CG PUSCH for UIR on the CG PUSCH for UIR resources. In one example, if the ratio of available resources for CG PUSCH for UIR (e.g., resources that do not overlap with DG PUSCH) to the resources of CG PUSCH for UIR, are greater than (or greater than or equal to) a threshold, the UE transmits CG PUSCH for UIR on the available resources (e.g., UE additionally transmits DG PUSCH), else the UE drops DG PUSCH and transmits CG PUSCH for UIR on the CG PUSCH for UIR resources. In one example, the aforementioned thresholds can be defined in the system specifications and/or configured or updated by SIB and/or RRC and/or MAC CE and/or L1 control signaling. In one example, the threshold can be signaled by the DCI Format scheduling the DG PUSCH.

In one example, the DG PUSCH and CG PUSCH for UIR overlap partially overlap on some resources. In one example, the UE transmits CG PUSCH for UIR on the resources allocated to CG PUSCH for UIR, and the UE transmits DG PUSCH, using the DG PUSCH resources (as indicated by the DCI Format scheduling the DG PUSCH) that do not overlap with CG PUSCH for UIR.

In one example, if the available resources for DG PUSCH (e.g., resources that do not overlap with CG PUSCH for UIR), are greater than (or greater than or equal to) a threshold, the UE transmits DG PUSCH on the available resources, else the UE drops DG PUSCH. In one example, if the ratio of available resources for DG PUSCH (e.g., resources that do not overlap with CG PUSCH for UIR) to the resources of DG PUSCH, are greater than (or greater than or equal to) a threshold, the UE transmits DG PUSCH on the available resources, else the UE drops DG PUSCH. In one example, the aforementioned thresholds can be defined in the system specifications and/or configured or updated by SIB and/or RRC and/or MAC CE and/or L1 control signaling. In one example, the threshold can be signaled by the DCI Format scheduling the DG PUSCH.

In one example, if the available resources for DG PUSCH (e.g., resources that do not overlap with CG PUSCH for UIR), are greater than (or greater than or equal to) a threshold, the UE transmits DG PUSCH on the available resources (e.g., UE additionally transmits CG PUSCH), else the UE drops CG PUSCH for UIR and transmits DG PUSCH on the resources indicated in the DCI Format scheduling DG PUSCH. In one example, if the ratio of available resources for DG PUSCH (e.g., resources that do not overlap with CG PUSCH for UIR) to the resources of DG PUSCH, are greater than (or greater than or equal to) a threshold, the UE transmits DG PUSCH on the available resources (e.g., UE additionally transmits CG PUSCH), else the UE drops CG PUSCH for UIR and transmits DG PUSCH on the resources indicated in the DCI Format scheduling DG PUSCH. In one example, the aforementioned thresholds can be defined in the system specifications and/or configured or updated by SIB and/or RRC and/or MAC CE and/or L1 control signaling. In one example, the threshold can be signaled by the DCI Format scheduling the DG PUSCH.

As aforementioned and illustrated in FIG. 13B, for CG PUSCH for UIR, there is a minimum gap between PN and CG PUSCH for UIR (e.g., X symbols).

In one example, if the CG PUSCH for UIR and the DG PUSCH overlap or are in a same slot, the UE expects that the DG PUSCH will start at or after the start of CG PUSCH for UIR, as in, e.g., FIGS. 16A, 16D, 16E, and 17.
In one example, if DG PUSCH starts before CG PUSCH for UIR, the UE drops the UE initiated report and the UE transmits DG PUSCH with UL-SCH.
In one example, if DG PUSCH starts before CG PUSCH for UIR, the UE drops the DG PUSCH and the UE transmits the CG PUSCH for UIR with the UE initiated report.

FIG. 22 illustrates an example of UE initiated reporting 2200 having minimum gaps between channels according to embodiments of the present disclosure. For example, the UE initiated reporting 2200 can be implemented by any of the UEs 111-116 of FIG. 1 and supported by BS 102 of FIG. 1. This example is for illustration only and other embodiments can be used without departing from the scope of the present disclosure.

In one example, as illustrated in FIG. 22, if the CG PUSCH for UIR and the DG PUSCH overlap or are in a same slot, the UE expects the DG PUSCH after a gap X (e.g., X symbols) from the PN associated with the CG PUSCH for UIR. In one example, X is measured from the end of the PN to the start of the DG PUSCH. In one example, X is measurement from start of PN to the start of the DG PUSCH. In one example, X is measured from the end of the PN to the end of the DG PUSCH. In one example, X is measurement from start of PN to the end of the DG PUSCH. In one example, X is measured from the end of the PN to the start of the slot of DG PUSCH. In one example, X is measurement from start of PN to the start of the slot of the DG PUSCH.

In one example, if DG PUSCH starts (or ends) less than (or less than or equal to) X before the end (or start) of the PN, or if the slot of DG PUSCH starts (or ends) less than (or less than or equal to) X before the end (or start) of the PN, the UE drops the UE initiated report and the UE transmits DG PUSCH with UL-SCH.

In one example, if DG PUSCH starts (or ends) less than (or less than or equal to) X before the end (or start) of the PN, or if the slot of DG PUSCH starts (or ends) less than (or less than or equal to) X before the end (or start) of the PN, the UE drops the DG PUSCH and the UE transmits the CG PUSCH for UIR with the UE initiated report.

In one example, as further illustrated in FIG. 22, the UE expects a minimum gap between the DCI scheduling DG PUSCH and the PN associated CG PUSCH for UIR (or the CG PUSCH for UIR), when the DG PUSCH and the CG PUSCH for UIR overlap. In one example, the UE expects the start (or end) of PN (or slot of PN) associated CG PUSCH for UIR (or the start/end or slot of CG PUSCH for UIR) to be at least (or more than) Y (e.g., Y symbols) from the end (or start) of the DCI (or slot of DCI) scheduling a DG PUSCH overlapping with CG PUSCH for UIR.
In one example, if the PN (or slot of PN) associated CG PUSCH for UIR (or CG PUSCH or slot of CG PUSCH for UIR) starts (or ends) less than (or less than or equal to) Y before the end (or start) of the DCI (or slot of DCI) scheduling a DG PUSCH overlapping with CG PUSCH for UIR, the UE drops the DG PUSCH and the UE transmits the CG PUSCH for UIR with the UE initiated report.
In one example, if the PN (or slot of PN) associated CG PUSCH for UIR (or CG PUSCH or slot of CG PUSCH for UIR) starts (or ends) less than (or less than or equal to) Y before the end (or start) of the DCI (or slot of DCI) scheduling a DG PUSCH overlapping with CG PUSCH for UIR, the UE drops the UE initiated report and the UE transmits DG PUSCH with UL-SCH.

In a variant of the aforementioned examples, the CG PUSCH for UIR can be replaced by PUCCH for UE initiated reporting, wherein the PUCCH can be configured as a periodic resource, or a semi-persistent resource that can be activated or deactivated by dynamic signaling, e.g., L1 control signaling (DCI Format or sequence-based) or higher layer dynamic signaling (e.g., MAC CE).

In a variant of the aforementioned example, the dynamically scheduled PUSCH (DG PUSCH) can be replaced by a configured grant PUSCH for user data (e.g., UL shared channel). In one example, configured grant PUSCH for user data, can be configured grant Type-1 PUSCH. In one example, configured grant PUSCH for user data, can be configured grant Type-2 PUSCH.

In one example, the present disclosure further considers three levels of multiplexing UCI types.

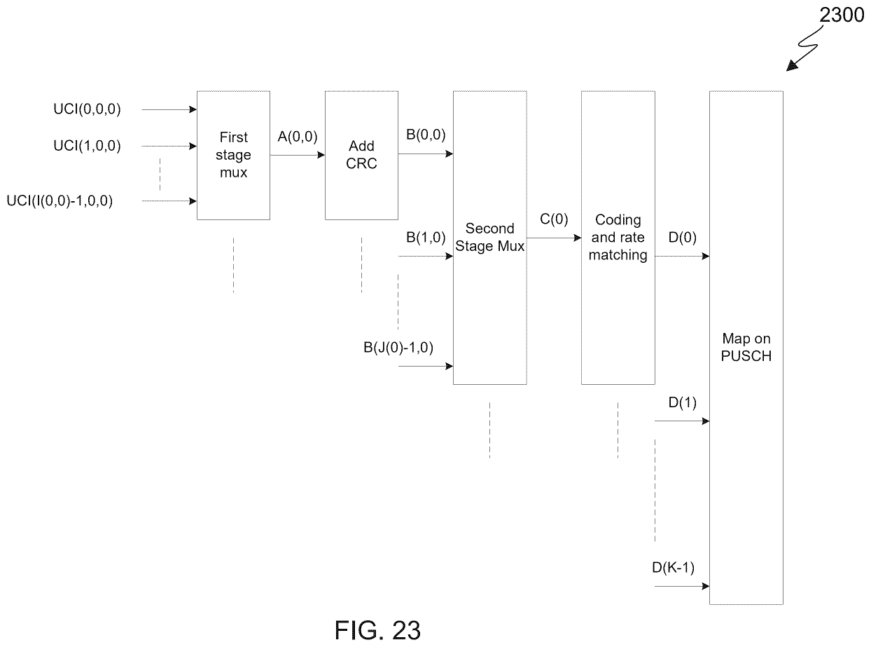

FIG. 23 illustrates an example of three levels of multiplexing 2300 according to embodiments of the present disclosure. For example, the three levels of multiplexing 2300 can be implemented by any of the UEs 111-116 of FIG. 1. This example is for illustration only and other embodiments can be used without departing from the scope of the present disclosure.

As illustrated in FIG. 23, a first level of multiplexing is at the information bit level, before CRC addition. A second level of multiplexing is at the information bit level, after CRC addition. A third level of multiplexing is after channel coding and rate matching.

The present disclosure considers UCI Type (i,j,k), where i=0, . . . I(j,k)−1, j=0, . . . , J(k)−1 and k=0, . . . , K−1. In one example, the number of UCI Types N is given by:

$$N = {\sum }_{k = 0}^{K - 1} {\sum }_{j = 0}^{J ( k ) - 1} I ( j , k )$$

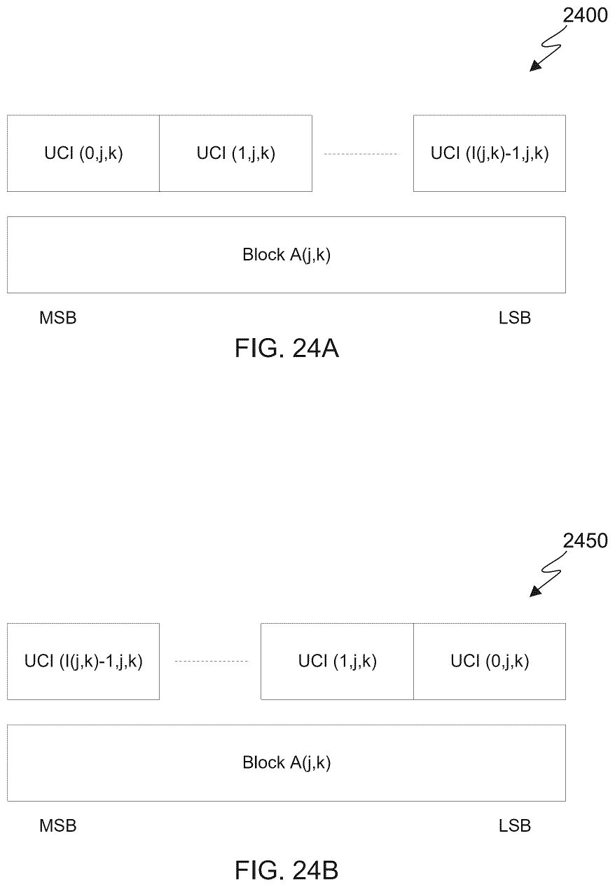

FIGS. 24A and 24B illustrate examples of first level multiplexing 2400 and 2450, respectively, according to embodiments of the present disclosure. For example, first level multiplexing 2400 and 2450 can be implemented by any of the UEs 111-116 of FIG. 1. These examples are for illustration only and other embodiments can be used without departing from the scope of the present disclosure.

For first level of multiplexing: UCI Types (0,j,k), (1,j,k), . . . , (I(j,k)−1,j,k) are multiplexed to generate block A(j,k). A CRC is added to each block A(j,k). In one example, the CRC is prepended to the block. In one example, the CRC is appended to the block. In one example, the block with added CRC is B(j,k). In one example, the UCI Types are multiplexed in order of UCI type index. In one example, as illustrated in FIG. 24A, UCI Type (0,j,k) is mapped to the most significant bits of block A(j,k), with the most significant bit of UCI Type (0,j,k) mapped to the most significant bit A(j,k), then the second most significant bit respectively and so on, followed by UCI type (1,j,k), starting with its most significant bit and so on. In one example, as illustrated in FIG. 24B, UCI Type (0,j,k) is mapped to the least significant bits of block A(j,k), with the least significant bit of UCI Type (0,j,k) mapped to the least significant bit A(j,k), then the second least significant bit respectively and so on, followed by UCI type (1,j,k), starting with its least significant bit and so on.

In one example, size of A(j,k) is at least N_{bits-min}. If A(j,k) would be less than N_{bits-min}, bits are padded (appended or prepended) to make A(j,k) equal to N_{bits-min}. In one example, N_{bits-min} is 12 bits. In one example, the channel coding scheme used is Polar Coding. In one example, the channel coding scheme used is LDPC.

In one example, size of B(j,k) is at least N_{bits-min}. In one example, if B(j,k) would be less than N_{bits-min}, bits are padded (appended or prepended) to A(j,k) to make B(j,k) equal to N_{bits-min}. In one example, the size of the CRC is selected such that B(j,k) is at least N_{bits-min}. In one example, N_{bits-min} is smallest size for Polar coding. In one example, N_{bits-min} is smallest size for LDPC. In one example, N_{bits-min} is 18 bits. In one example, the channel coding scheme used is Polar Coding. In one example, the channel coding scheme used is LDPC.

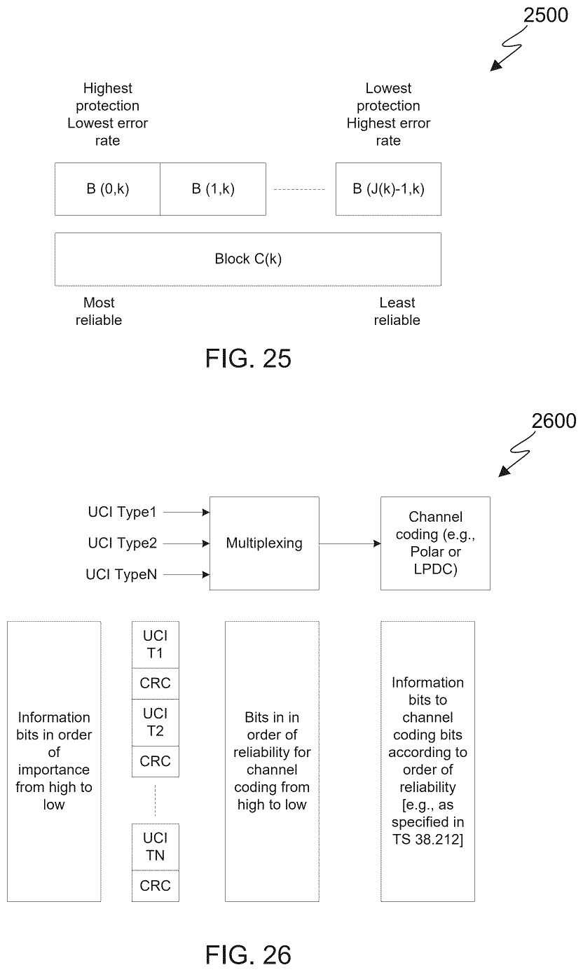

FIG. 25 illustrates an example of second level multiplexing 2500 according to embodiments of the present disclosure. For example, second level multiplexing 2500 can be implemented by any of the UEs 111-116 of FIG. 1. This example is for illustration only and other embodiments can be used without departing from the scope of the present disclosure.

For second level of multiplexing: blocks B(0,k), B(1,k), . . . , B(J(k)−1,k) are multiplexed to generate block C(k). The multiplexed blocks are encoded and rate matched to generate block D (k). In one example, the rate matching can be based on a beta offset that depends on k, e.g., β(k).

In one example, as illustrated in FIG. 25, the blocks B(0,k), B(1,k), . . . , B(J(k)−1,k) are arranged in order of error protection requirements e.g., descending order of error protection requirement, where B(0,k) has highest error protection requirement (e.g., lowest error rate), followed by B(1,k) which has the second highest error protection requirement (e.g., second lowest error rate), and so on, until B(J(k)−1,k) with the lowest error protection requirement (e.g., highest error rate), the bits of C(k) are arranged in order of reliability (e.g., most significant bit of C(k) has the highest reliability) at the encoder input. The mapping of B(0,k), B(1,k), . . . , B(J(k)−1,k) to C(k) is such that the block (e.g., B(0,k)) with the highest error protection requirement (e.g., lowest error rate) is mapped to the bits with the highest reliability at the encoder input, followed by the block (e.g., B(1,k)) with the second highest error protection requirement (e.g., second lowest error rate) is mapped to the bits with the next highest reliability, and so on.

In one example, each block C(k) is configured with a target beta offset, e.g., β(k). The target beta offset can determine the number of modulation coded symbols or resource elements to allocate to block C(k) after coding, rate matching and modulation. In one example, the number coded modulation symbols per layer or number of resource elements allocated to D(k) can be given by one of the following:

$$⌈ \frac{\begin{matrix}( size of C ( k ) ) \cdot β ( k ) \cdot \\ ( REs available for UCI or UL - SCH transmission )\end{matrix}}{Sum of size of all code blocks of UL - SCH} ⌉ ;$$

$$⌊ \frac{\begin{matrix}( size of C ( k ) ) \cdot β ( k ) \cdot \\ ( REs available for UCI or UL - SCH transmission )\end{matrix}}{Sum of size of all code blocks of UL - SCH} ⌋ ;$$

$$round [ \frac{\begin{matrix}( size of C ( k ) ) \cdot β ( k ) \cdot \\ ( REs available for UCI or UL - SCH transmission )\end{matrix}}{Sum of size of all code blocks of UL - SCH} ] ;$$

$$⌈ \frac{( size of C ( k ) ) \cdot β ( k )}{R \cdot {Q}_{m}} ⌉ ;$$

$$⌊ \frac{( size of C ( k ) ) \cdot β ( k )}{R \cdot {Q}_{m}} ⌋ ;$$

$$and$$

$$round [ \frac{( size of C ( k ) ) \cdot β ( k )}{R \cdot {Q}_{m}} ] .$$

In the above equations R is the target code rate of the UL channel carrying UCI, e.g., reference or target code rate, e.g., signaled by L1 control information (e.g., DCI) or configured by higher layers. In the above equations Qₘ is modulation order of the UL channel carrying UCI, e.g., reference or target code rate, e.g., signaled by L1 control information (e.g., DCI) or configured by higher layers.

In the above equations, β(k) is the beta offset for C(k). In one example, a single β(k) value is configured for C(k) and that value is used. In one example, multiple β(k) values are configured for C(k), one of the values (e.g., index corresponding to value) is indicated by L1 control information (e.g., DCI Format or sequence-based signal) scheduling the UL transmission with UCI, and the signaled value is used. In one example, multiple β(k) values are configured for C(k), there is no signaling of β(k) index in the L1 control information (e.g., DCI Format) scheduling the UL transmission, a pre-determined index of the multiple values of β(k) is used, e.g., value corresponding to index 0 or value corresponding to largest index or value corresponding to a configured index.

The third level of multiplexing: blocks D(0), D(1), . . . , D(K−1) are multiplexed and mapped into the physical UL channel (e.g., PUSCH or PUCCH) transmitting UCI. In one example, in example UCI is transmitted into a physical UL channel, without UL-shared channel (UL-SCH). In one example, in example UCI is transmitted into a physical UL channel, with UL-SCH.

In one example, of the aforementioned examples, the value of K=1.

In one example, of the aforementioned examples, I(j,k)=I, where I is independent of j and k, i.e., a constant. In one example, I can be defined in the system specifications. In one example, I=1. In one example, I is determined based on configuration information provided to the UE for the different UCI Types.

In one example, of the aforementioned examples, I(j,k)=I(j), where I is independent of k but depends on j.

In one example, of the aforementioned examples, I(j,k)=I(k), where I is independent of j but depends on k.

In one example, of the aforementioned examples, J(k)=J, where J is independent of k, i.e., a constant. In one example, J can be defined in the system specifications. In one example, j is determined based on configuration information provided to the UE for the different UCI Types.

FIG. 26 illustrates an example of multiplexing of UCI types and channel coding 2600 according to embodiments of the present disclosure. For example, multiplexing of UCI types and channel coding 2600 can be implemented by any of the UEs 111-116 of FIG. 1. This example is for illustration only and other embodiments can be used without departing from the scope of the present disclosure.

In one example, I=1, J=N and K=1. In FIG. 26, channel coding supports unequal error (bit-level) protection, and the information bits are mapped/interleaved to the channel coding bits according to the desired order of reliability.

Bits for UCI Type-n: cₙₖ, k=0, . . . , Aₙ−1, wherein Aₙ is the number of bits for UCI-Type-n. n=1, . . . , N, wherein N is the number of UCI Types.

Add CRC: CRC for UCI Type-n can be given by pₙ₀, pₙ₁, . . . , p_{n(L}_{ₙ}₋₁₎, wherein Lₙ is the number of CRC bits for UCI-Type-n. n=1, . . . , N, wherein N is the number of UCI Types. In one example, Lₙ depends on the payload size of UCI-Type-n (e.g., Aₙ).

CRC for each UCI-Type can be appended or prepended to the start or the end of the corresponding UCI Type.

Bits for UCI Type-n: bₙₖ, k=0, . . . , Bₙ−1, wherein Bₙ=Aₙ+Lₙ is the number of bits for UCI-Type-n. n=1, . . . , N, wherein N is the number of UCI Types.

Concatenate the UCI Types in order of error protection requirement or lower error rate or importance or priority. The first UCI-Type to be concatenated is the one with higher error protection requirement or lower error rate or higher importance or higher priority, and proceed in order for the remaining UCI-Types. In one example, the reliability at the encoder input of the concatenated bits is in descending order, i.e., the UCI-Types with higher protection requirement or lower error rate or higher importance or higher priority are mapped to the bits with the highest reliability at the encoder input.

The following is an example or pseudo code for multiplexing the bits:

```
Set k = 0 and n = 1
While n ≤ N
    Set j = 0
    While j < Bₙ
        cₖ = bₙⱼ
        k = k + 1
        j = j + 1
    End While
    n = n + 1
End while
```

cₖ, where k=0, . . . , C−1 and

$$C = {\sum }_{n = 1}^{N} {B}_{n}$$

is the concatenated UCI information block that is presented to the channel coding block.

In one example, N=3 (see second row of Table 4 below), UCI Type 1 is HARQ-ACK, UCI Type 2 is CSI part1, and UCI Type 3 is CSI part 2. In one example, the order UCI types from highest error protection to lowest error protection or from lowest error rate to highest error rate is: (1) HARQ-ACK; (2) CSI part1; and (3) CSI part 2.

Further, Table 4 below gives various examples of N and UCI Types. In one example, the order UCI types from highest error protection to lowest error protection or from lowest error rate to highest error rate is: (1) UCI Type1; (2) UCI Type2; (3) UCI Type3; (4) UCI Type4; and so on.

TABLE 4

| N | UCU Type 1 | UCU Type 2 | UCI Type 3 | UCI Type 4 | UCU Type5 |
|---|---|---|---|---|---|
| 3 | HARQ-ACK | CSI Part1 | CSI Part2 | — | — |
| 2 | HARQ-ACK | CSI | — | — | — |
| 3 | HARQ-ACK | CSI Part1 | CSI Part2 | — | — |
| | and/or SR | | | | |
| | and/or LRR | | | | |
| 2 | HARQ-ACK | CSI | — | — | — |
| | and/or SR | | | | |
| | and/or LRR | | | | |
| 3 | HARQ-ACK | CSI Part1 | CSI Part2 | — | — |
| | and/or SR | | | | |
| | and/or LRR | | | | |
| | and/or Ind for | | | | |
| | UE initiated | | | | |
| | report | | | | |
| 2 | HARQ-ACK | CSI | — | — | — |
| | and/or SR | | | | |
| | and/or LRR | | | | |
| | and/or Ind for | | | | |
| | UE initiated | | | | |
| | report | | | | |
| 4 | HARQ-ACK | SR or LRR | CSI Part1 | CSI Part2 | — |
| 3 | HARQ-ACK | SR or LRR | CSI | — | — |
| 4 | HARQ-ACK | Indicator for | CSI Part1 | CSI Part2 | — |
| | | UE initiated | | | |
| | | report | | | |
| 3 | HARQ-ACK | Indicator for | CSI | — | — |
| | | UE initiated | | | |
| | | report | | | |
| 4 | HARQ-ACK | Indicator for | CSI Part1 | CSI Part2 | — |
| | | UE initiated | | | |
| | | report | | | |
| 3 | HARQ-ACK | Indicator for | CSI | — | — |
| | | UE initiated | | | |
| | | report | | | |
| 4 | HARQ-ACK | Indicator for | CSI Part1 | CSI Part2 | — |
| | and/or SR | UE initiated | | | |
| | and/or LRR | report | | | |
| 3 | HARQ-ACK | Indicator for | CSI | — | — |
| | and/or SR | UE initiated | | | |
| | and/or LRR | report | | | |
| 5 | HARQ-ACK | Indicator for | SR or LRR | CSI Part1 | CSI Part2 |
| | | UE initiated | | | |
| | | report | | | |
| 4 | HARQ-ACK | Indicator for | SR or LRR | CSI | — |
| | | UE initiated | | | |
| | | report | | | |
| 5 | HARQ-ACK | SR or LRR | Indicator for | CSI Part1 | CSI Part2 |
| | | | UE initiated | | |
| | | | report | | |
| 4 | HARQ-ACK | SR or LRR | Indicator for | CSI | — |
| | | | UE initiated | | |
| | | | report | | |

In the present disclosure, other variations in the order of UCI Types from those shown in Table 4 above can be considered.

In one example, UCI Type A indicates the content and/or structure of UL transmission (e.g., payload size for each UCI Type and payload size of UL-SCH and/or code rate of each UCI type and/or or code rate of UL-SCH and/or modulation order and/or number of REs (or coded bits) of each UCI type and/or number of REs (or code bits) of UL-SCH). In one example, UCI Type A has a highest error protection requirement or lowest error rate of the UCI Types being multiplexed on the UL transmission.

In one example, a UE receives configuration information of UCI Types, wherein the configuration information includes error protection requirement or target error rate, wherein UCI types starting from the UCI type with the highest error protection or lowest error rate are mapped to bits at the input to the encoder starting from the most reliable bit. In one example, a UE is configured an order of UCI types from the highest order to the lowest order or vice versa, wherein UCI types starting from the highest order (or lowest order in an alternate example) are mapped to bits at the input to the encoder starting from the most reliable bit.

In one examples, a UE determines UCI Types to include in an uplink transmission. In one example, the UCI Types are in response to a semi-static configuration (e.g., configuration by higher layers) and/or in response to a dynamic signal (e.g., L1 control (e.g., DCI Format or sequence-based signaling)). In one example, the UE multiplexes the UCI types as described in this disclosure, wherein:
A CRC is calculated for the payload of a UCI type, or the concatenated payloads for multiple UCI Types.
The information blocks with CRC are mapped to encoder input, wherein UCI types with higher error protection or lower error rates are mapped to more reliable bits at the encoder input.

The multiplexed information blocks are encoded, rate matched, and mapped to the physical uplink channel for transmission.

In one example, UL-SCH is multiplexed and transmitted on an UL physical channel (e.g., PUSCH). In one example, the UL-SCH is transmitted in N_{c} code blocks. In one example, the uplink control information (UCI) is transmitted on the UL physical channel. In one example, the UCI is separated into M blocks. In one example, M≤N_{c}. In one example, M=N_{c}. In one example, the size of the M UCI blocks is Aᵢ, wherein i=0, 1, . . . , M−1. In one example, a CRC is concatenated (appended or prepended) to each of the M UCI blocks, wherein the size of the UCI block with CRC is Bᵢ, wherein i=0, 1, . . . , M−1. In one example, the M transport blocks are multiplexed to M of the N_{c} code blocks. In one example, the M of the N_{c} code blocks are the first M of the N_{c} code blocks. In one example, the M of the N_{c} code blocks are the list M of the N_{c} code blocks. In one example, the M of the N_{c} code blocks are configured by higher layers. In one example, the M of the N_{c} code blocks are configured by indicated to the UE, e.g., by DCI Format or sequence-based signaling or MAC CE. In one example, the M of the N_{c} code blocks are determined by a rule. In one example, for code block of the N_{c} code blocks, where UCI is multiplexed, the UCI bits are mapped to the most reliable bits of the code block at the encoder input.

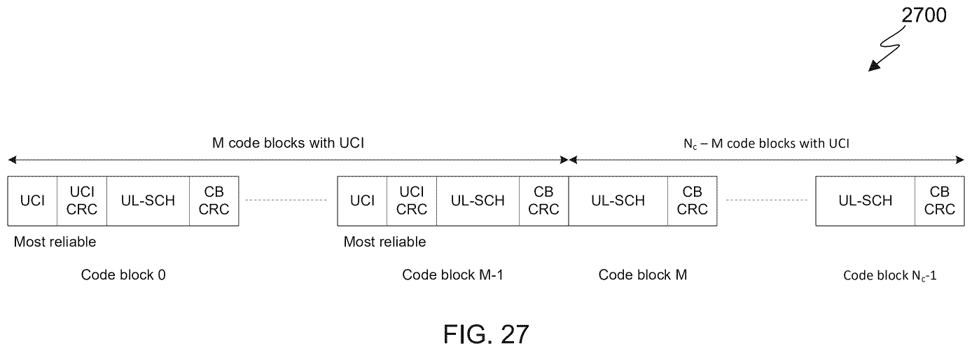

FIG. 27 illustrates an example of multiplexing UCI 2700 to the M of the N_{c} code blocks according to embodiments of the present disclosure. For example, multiplexing of UCI 2700 can be implemented by any of the UEs 111-116 of FIG. 1. This example is for illustration only and other embodiments can be used without departing from the scope of the present disclosure.

As illustrated in FIG. 27, the code blocks where UCI is multiplexed include UCI and UCI CRC mapped to the most reliable bits at the encoder input followed by UL-SCH and code block (CB) CRC. In one example, the UCI CRC is calculated over the UCI bits multiplexed on the code block. In one example, the CB-CRC can be calculated over the UL-SCH bits of the code block. In one example, the CB-CRC can be calculated over the UCI+UL-SCH bits of code block. In one example, the CB-CRC can be calculated over the UCI+UCI CRC+UL-SCH bits of the code block. In one example, for code blocks with no UCI, the CB-CRC is calculated over the UL-SCH bits of the code block. In one example, as illustrated in FIG. 27, the UCI-CRC is prepended to the UCI bits. In one example, the UCI-CRC is appended to the UCI bits. In one example, the CRC is prepended to the UL-SCH bits as further illustrated in FIG. 27. In one example, the CB-CRC is appended to the UL-SCH bits.

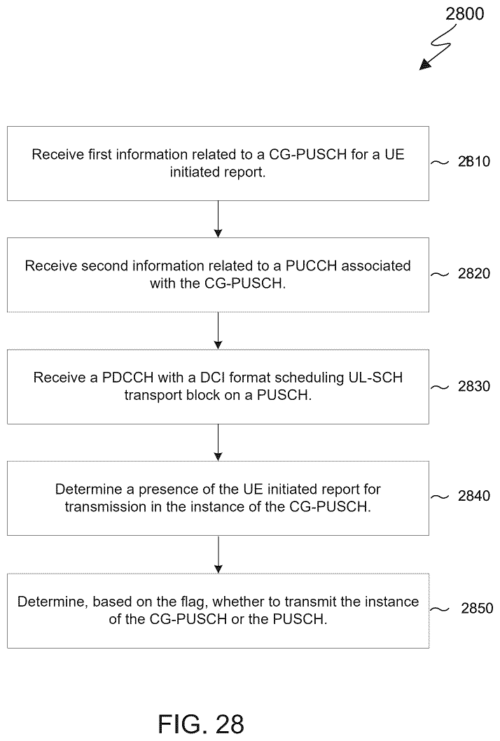

FIG. 28 illustrates an example method 2800 performed by UE in a wireless communication system according to embodiments of the present disclosure. The method 2800 of FIG. 28 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2800 is for illustration only and other embodiments can be used without departing from the scope of the present disclosure.

The method begins with the UE receiving first information related to a CG-PUSCH for a UE initiated report (2810). The UE then receives second information related to a PUCCH associated with the CG-PUSCH (2820). The UE then receives a PDCCH with a DCI format scheduling UL-SCH transport block on a PUSCH (2830). For example, in 2830, the DCI includes a flag and an instance of the CG-PUSCH and the PUSCH collide. In various embodiments, the instance of the CG-PUSCH and the PUSCH collide when the instance of the CG-PUSCH and the PUSCH are scheduled in a same slot.

The UE determines a presence of the UE initiated report for transmission in the instance of the CG-PUSCH (2840). The UE then determines, based on the flag, whether to transmit the instance of the CG-PUSCH or the PUSCH (2850). In various embodiments, when the PUSCH is dropped, the EU multiplexes the UL-SCH transport block with the UE initiated report on the instance of the CG-PUSCH. In various embodiments, when the PUSCH is dropped, the UE transmits a PUCCH associated with the instance of the GC-PUSCH. The PUCCH indicates whether the UL-SCH transport block is multiplexed with the UE initiated report on the instance of the CG-PUSCH. In various embodiments, when the instance of the CG-PUSCH is dropped, the UE transmits a PUCCH associated with the instance of the CG-PUSCH. The PUCCH indicates whether the UE initiated report is multiplexed with the UL-SCH transport block on the PUSCH. In various embodiments, the UE drops the PUSCH when the PUCCH associated with the instance of the CG-PUSCH starts earlier than a time T1 after reception of the DCI format scheduling the PUSCH. In various embodiments, the UE drops the instance of the CG-PUSCH when the PUSCH starts earlier than a time T2 after the PUCCH associated with the instance of the CG-PUSCH.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information related to a configured grant physical uplink shared channel (CG-PUSCH) for a UE initiated report,
receive second information related to a physical uplink control channel (PUCCH) associated with the CG-PUSCH, and
receive a physical downlink control channel (PDCCH) with a downlink control information (DCI) format scheduling uplink shared channel (UL-SCH) transport block on a PUSCH, wherein:
the DCI includes a flag, and
an instance of the CG-PUSCH and the PUSCH collide; and
a processor operably coupled to the transceiver, the processor configured to:
determine a presence of the UE initiated report for transmission in the instance of the CG-PUSCH, and
determine, based on the flag, whether to transmit the instance of the CG-PUSCH or the PUSCH.

2. The UE of claim 1, wherein the instance of the CG-PUSCH and the PUSCH collide when the instance of the CG-PUSCH and the PUSCH are scheduled in a same slot.

3. The UE of claim 1, wherein the processor is further configured to, when the PUSCH is dropped, multiplex the UL-SCH transport block with the UE initiated report on the instance of the CG-PUSCH.

4. The UE of claim 1, wherein:
the transceiver is further configured to, when the PUSCH is dropped, transmit a PUCCH associated with the instance of the GC-PUSCH, and
the PUCCH indicates whether the UL-SCH transport block is multiplexed with the UE initiated report on the instance of the CG-PUSCH.

5. The UE of claim 1, wherein:
the transceiver is further configured to, when the instance of the CG-PUSCH is dropped, transmit a PUCCH associated with the instance of the CG-PUSCH, and
the PUCCH indicates whether the UE initiated report is multiplexed with the UL-SCH transport block on the PUSCH.

6. The UE of claim 1, wherein, the transceiver is further configured to drop the PUSCH when the PUCCH associated with the instance of the CG-PUSCH starts earlier than a time T1 after reception of the DCI format scheduling the PUSCH.

7. The UE of claim 1, wherein the transceiver is further configured to drop the instance of the CG-PUSCH when the PUSCH starts earlier than a time T2 after the PUCCH associated with the instance of the CG-PUSCH.

8. A base station (BS), comprising:
a transceiver configured to:
transmit first information related to a configured grant physical uplink shared channel (CG-PUSCH) for a UE initiated report, and
transmit second information related to a physical uplink control channel (PUCCH) associated with the CG-PUSCH; and
a processor operably coupled to the transceiver, the processor configured to schedule an uplink shared channel (UL-SCH) transport block on a physical uplink shared channel (PUSCH),
wherein the transceiver is further configured to transmit a physical downlink control channel (PDCCH) with a downlink control information (DCI) format related to scheduling of the UL-SCH on the PUSCH,
wherein the DCI includes a flag, and
wherein the flag indicates whether to transmit an instance of the CG-PUSCH or the PUSCH, when:
the instance of the CG-PUSCH and the PUSCH collide, and
a user equipment (UE) has a UE initiated report to transmit on the instance of the CG-PUSCH.

9. The BS of claim 8, wherein the instance of the CG-PUSCH and the PUSCH collide when the instance of the CG-PUSCH and the PUSCH are scheduled in a same slot.

10. The BS of claim 8, wherein:
the flag indicates to drop the PUSCH, and
the transceiver is further configured to:
receive the PUCCH, and the PUCCH indicates a presence of a UE initiated report, and
receive the instance of the CG-PUSCH with the UE initiated report.

11. The BS of claim 8, wherein:
the flag indicates to drop the PUSCH,
the transceiver is further configured to, receive the PUCCH, and
the PUCCH indicates whether the UL-SCH transport block is multiplexed with the UE initiated report on the instance of the CG-PUSCH.

12. The BS of claim 8, wherein:
the flag indicates to drop an instance of the GC-PUSCH,
the transceiver is further configured to receive a PUCCH associated with the instance of the CG-PUSCH, and
the PUCCH indicates whether the UE initiated report is multiplexed with the UL-SCH transport block on the PUSCH.

13. The BS of claim 8, wherein the PUSCH colliding with an instance of the CG-PUSCH starts at least a time T2 after the PUCCH corresponding to the instance of the CG-PUSCH.

14. A method of operating a user equipment (UE), the method comprising:
receiving first information related to a configured grant physical uplink shared channel (CG-PUSCH) for a UE initiated report;
receiving second information related to a physical uplink control channel (PUCCH) associated with the CG-PUSCH;
receiving a physical downlink control channel (PDCCH) with a downlink control information (DCI) format scheduling uplink shared channel (UL-SCH) transport block on a PUSCH, wherein:
the DCI includes a flag, and
an instance of the CG-PUSCH and the PUSCH collide;
determining a presence of the UE initiated report for transmission in the instance of the CG-PUSCH; and
determining, based on the flag, whether to transmit the instance of the CG-PUSCH or the PUSCH.

15. The method of claim 14, wherein the instance of the CG-PUSCH and the PUSCH collide when the instance of the CG-PUSCH and the PUSCH are scheduled in a same slot.

16. The method of claim 14, further comprising, when the PUSCH is dropped, multiplexing the UL-SCH transport block with the UE initiated report on the instance of the CG-PUSCH.

17. The method of claim 14, further comprising:
when the PUSCH is dropped, transmitting a PUCCH associated with the instance of the GC-PUSCH,
wherein the PUCCH indicates whether the UL-SCH transport block is multiplexed with the UE initiated report on the instance of the CG-PUSCH.

18. The method of claim 14, further comprising:
when the instance of the CG-PUSCH is dropped, transmitting a PUCCH associated with the instance of the CG-PUSCH,
wherein the PUCCH indicates whether the UE initiated report is multiplexed with the UL-SCH transport block on the PUSCH.

19. The method of claim 14, further comprising dropping the PUSCH when the PUCCH associated with the instance of the CG-PUSCH starts earlier than a time T1 after reception of the DCI format scheduling the PUSCH.

20. The method of claim 14, further comprising dropping the instance of the CG-PUSCH when the PUSCH starts earlier than a time T2 after the PUCCH associated with the instance of the CG-PUSCH.
